(19) United States
(12) Patent Application Publication
(10) Pub. No.: US 2026/0067096 A1
(43) Pub. Date: Mar. 5, 2026

(54) SUPPORT FOR ADDITIONAL CRYPTOGRAPHIC ALGORITHMS USING AN INLINE CRYPTOGRAPHIC HARDWARE COMPONENT

(71) Applicant: QUALCOMM Incorporated, San Diego, CA (US)

(72) Inventors: Yashavantha RAO, Hyderabad (IN); Dafna SHAOOL, Binyamina (IL); Changjian GAO, San Diego, CA (US); Jeevan VISVESHA, Bengaluru (IN); Neeraj Kumar SONI, Hyderabad (IN); Itsik BOGER, Binyamina (IL); Santosh Pavan Kumar DRONAMRAJU, Hyderabad (IN)

(21) Appl. No.: 19/099,029

(22) PCT Filed: Jul. 20, 2023
(86) PCT No.: PCT/US2023/070623

§ 371 Date: Jan. 27, 2025

(30) Foreign Application Priority Data
Aug. 28, 2022 (IL) 295974

(51) Int. Cl. H04L 9/32; G06F 21/57

(52) U.S. Cl. CPC H04L 9/3242; G06F 21/575; G06F 2221/034

(57) ABSTRACT

Systems and techniques are described herein for offloading cryptographic services. For example, a method may include receiving a request to provide a cryptographic service type and initiating a cryptographic algorithm in a cryptographic hardware component, where the cryptographic algorithm is associated with the cryptographic service type. The method may further include applying a cryptographic operation to data to obtain a cryptographic result. The cryptographic operation is associated with the cryptographic algorithm. The method may further include storing at least a portion of the cryptographic result in a hardware register of the cryptographic hardware component. The cryptographic result is configured for use for performing a cryptographic action.

### CROSS-REFERENCE TO RELATED APPLICATIONS

This application for patent is a 371 of international Patent Application PCT/US2023/070623, filed Jul. 20, 2023, which claims priority to Israel Patent Application 295974, filed Aug. 28, 2022, all of which are hereby incorporated by referenced in their entirety and for all purposes.

### FIELD

The present disclosure generally relates to encryption and decryption of data. In some examples, aspects of the present disclosure are related to systems and techniques for offloading certain aspects of integrity verification, authenticated encryption, and/or data decryption to a cryptographic hardware component.

### BACKGROUND

A variety of scenarios exist in which the integrity of data may be verified, or in which it is desirable to perform authenticated encryption and/or authenticated decryption on data. Such operations generally relate to helping to ensure that data has not been altered, for example, before the data is to be consumed or otherwise used by a computing device.

For example, integrity verification may be performed as part of secure boot process to ensure the integrity of the image to being loaded, or to verify the integrity of data blocks storing all or any portion of a file system. As another example, authenticated encryption and decryption may be performed in order to provide data confidentiality as well as data integrity verification for runtime data. Such operations are generally performed using compute resources (e.g., software executing on a processor) of a particular computing device, which are also used for performing other functionality of the device. Accordingly, such operations may adversely impact the performance characteristics of the device, as the compute resources of the device are used for integrity verification and/or authenticated encryption/decryption when they could otherwise be performing other operations.

### SUMMARY

In some examples, systems and techniques are described for providing offloading services. According to at least one illustrative example, a method of offloading cryptographic services is provided. The method includes: receiving a request to provide a cryptographic service type; initiating a cryptographic algorithm in a cryptographic hardware component, wherein the cryptographic algorithm is associated with the cryptographic service type; applying a cryptographic operation to data to obtain a cryptographic result, wherein the cryptographic operation is associated with the cryptographic algorithm; and storing at least a portion of the cryptographic result in a hardware register of the cryptographic hardware component, wherein the cryptographic result is configured for use for performing a cryptographic action.

In another example, an apparatus for offloading cryptographic services is provided that includes at least one memory, at least one processor, and a cryptographic hardware component coupled to the at least one memory and the at least one processor. The cryptographic hardware component is configured to: receive a request to provide a cryptographic service type; initiate a cryptographic algorithm in the cryptographic hardware component, wherein the cryptographic algorithm is associated with the cryptographic service type; apply a cryptographic operation to data to obtain a cryptographic result, wherein the cryptographic operation is associated with the cryptographic algorithm; and store at least a portion of the cryptographic result in a hardware register of the cryptographic hardware component, wherein the cryptographic result is configured for use for performing a cryptographic action.

In another example, a non-transitory computer-readable medium is provided that has stored thereon instructions that, when executed by one or more processors, cause the one or more processors to: receive a request to provide a cryptographic service type; initiate a cryptographic algorithm in a cryptographic hardware component, wherein the cryptographic algorithm is associated with the cryptographic service type; apply a cryptographic operation to data to obtain a cryptographic result, wherein the cryptographic operation is associated with the cryptographic algorithm; and store at least a portion of the cryptographic result in a hardware register of the cryptographic hardware component, wherein the cryptographic result is configured for use for performing a cryptographic action.

In another example, an apparatus for offloading cryptographic services is provided that includes: means for receiving a request to provide a cryptographic service type; means for initiating a cryptographic algorithm in a cryptographic hardware component, wherein the cryptographic algorithm is associated with the cryptographic service type; means for applying a cryptographic operation to data to obtain a cryptographic result, wherein the cryptographic operation is associated with the cryptographic algorithm; and means for storing at least a portion of the cryptographic result in a hardware register of the cryptographic hardware component, wherein the cryptographic result is configured for use for performing a cryptographic action.

In some aspects, one or more of the apparatuses described herein is, is part of, and/or includes a mobile or wireless communication device (e.g., a mobile telephone or other mobile device), an extended reality (XR) device or system (e.g., a virtual reality (VR) device, an augmented reality (AR) device, or a mixed reality (MR) device), a wearable device (e.g., a network-connected watch or other wearable device), a vehicle or a computing device or component of a vehicle, a camera, a personal computer, a laptop computer, a server computer or server device (e.g., an edge or cloud-based server, a personal computer acting as a server device, a mobile device such as a mobile phone acting as a server device, an XR device acting as a server device, a vehicle acting as a server device, a network router, or other device acting as a server device), any combination thereof, and/or other type of device. In some aspects, the apparatus(es) include(s) a camera or multiple cameras for capturing one or more images. In some aspects, the apparatus(es) include(s) a display for displaying one or more images, notifications, and/or other displayable data. In some aspects, the apparatus(es) include(s) can include one or more sensors (e.g., one or more inertial measurement units (IMUs), such as one or more gyroscopes, one or more gyrometers, one or more accelerometers, any combination thereof, and/or other sensor.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and examples, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating a computing device, in accordance with some examples;

FIG. 2 is a block diagram illustrating a cryptographic hardware component, in accordance with some examples;

FIG. 3 is a flow diagram illustrating an example of a process for offloading integrity verification for data, in accordance with some examples;

FIG. 4 is a flow diagram illustrating an example of a process for offloading authenticated encryption, in accordance with some examples;

FIG. 5 is a flow diagram illustrating another example of a process for offloading authenticated encryption, in accordance with some examples;

FIG. 6 is a flow diagram illustrating an example of a process for offloading authenticated decryption, in accordance with some examples;

FIG. 7 is a flow diagram illustrating an example of a process for offloading decryption of software images encrypted on another device, in accordance with some examples;

FIG. 8 is a flow diagram illustrating another example of a process for offloading decryption of software images encrypted on another device, in accordance with some examples; and

FIG. 9 is a diagram illustrating an example of a computing system for implementing certain aspects described herein.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of examples of the application. However, it will be apparent that various examples may be practiced without these specific details. The figures and description are not intended to be restrictive. Additionally, certain details known to those of ordinary skill in the art may be omitted to avoid obscuring the description.

In the below description of the figures, any component described with regard to a figure, in various examples described herein, may be equivalent to one or more like-named components described with regard to any other figure. For brevity, descriptions of these components may not be wholly repeated with regard to each figure. Thus, each and every example of the components of each figure is incorporated by reference and assumed to be optionally present within every other figure having one or more like-named components. Additionally, in accordance with various examples described herein, any description of the components of a figure is to be interpreted as an optional example, which may be implemented in addition to, in conjunction with, or in place of the examples described with regard to a corresponding like-named component in any other figure.

The ensuing description provides exemplary examples only, and is not intended to limit the scope, applicability, or configuration of the disclosure. Rather, the ensuing description of the exemplary examples will provide those skilled in the art with an enabling description for implementing an exemplary example. It should be understood that various changes may be made in the function and arrangement of elements without departing from the spirit and scope of the application as set forth in the appended claims.

Computing devices, such as mobile devices, may include various types of storage devices (e.g., flash storage). Such storage devices are often used to store data. To help ensure device security, all or any portion of the data may be subjected to various cryptographic techniques, such as encrypting sensitive data, which is decrypted when the data is needed. In order to support encryption and decryption of data, the computing device may include an interface (e.g., a host controller interface) that is used to provide an interface between the storage device and other components of the computing device. The interface may be configured to conform to certain standards (e.g., the Joint Electron Device Engineering Council (JEDEC) Universal Flash Storage Host Controller Interface (UFSHCI) standard and/or other standard(s)), which are designed to provide common techniques for implementing various functionality in relation to the storage device, such as encryption and decryption of data stored on the storage device. Thus, components in the data path between storage devices and other components of a computing device (e.g., memory) are often designed to conform with such standards.

One example of a component in the data path between a storage device and other components of a computing device may be a cryptographic hardware component. In some examples, a cryptographic hardware component is a hardware component separate from the one or more processors of a computing device, and that provides inline cryptographic services on data passing to or from a storage device of a computing device, thereby offloading at least a portion of the cryptographic services from the one or more processors of the computing device, which allows the processor to perform other operations. Such offloading may improve the performance of the computing device, as it allows the one or more processors of the computing device to perform other operations.

In order to further improve the performance of computing devices, systems and techniques are needed for offloading additional cryptographic operations from the one or more processors of a computing device to a cryptographic hardware component of the computing device. However, such a cryptographic hardware component conforming to an interface standard (e.g., JEDEC, etc.) may not allow for such additional offloading of cryptographic techniques, if the standard lacks support for certain cryptographic algorithms.

Systems, apparatuses, processes (also referred to as methods), and computer-readable media (collectively referred to as “systems and techniques”) are described herein for offloading one or more cryptographic techniques to a cryptographic hardware component. In one illustrative example, the one or more additional cryptographic techniques or services may include integrity verification. Integrity verification is a technique for determining whether stored data has been altered in an unauthorized or unexpected manner. As an example, integrity verification may be performed during a secure boot process to verify the integrity of images (e.g., operating system images, software images, etc.) being loaded (e.g., into memory). If the integrity is verified, then the image, or portion thereof, may be loaded. If the integrity cannot be verified, the image may not be loaded. As another example, techniques such as using a Merkle tree (which may be referred to as a hash tree) may be performed to verify the integrity of blocks of stored data before the data is moved from a storage device to memory, where the data is used by the computing device (e.g., operated on using a processor of the computing device).

In some examples, integrity verification includes the use of an algorithm for hashing (e.g., a secure hash algorithm (SHA)). Such an algorithm operates on input data to produce an output, which may be referred to as a digest. In some examples, the digest generated may be referred to as a cryptographic result. A digest may be a fixed size (e.g., a fixed number of bits) regardless of the size of the data on which the hash algorithm operates. The digest produced by a hash algorithm for a given data item has a very low probability of being the same as the digest generated using any other data as input for the hash algorithm. Thus, the digest corresponding to data may be considered unique for the data within realistic constraints of time, compute resources, and variety of potential input data. In some examples, generating a digest for data using a hash algorithm allows for the digest to be compared with a digest previously generated for the data, with a match indicating an integrity check pass (e.g., the integrity of the data is verified). Performing such a comparison may be one example of performing a cryptographic action using a cryptographic result.

The one or more cryptographic techniques or services may additionally or alternatively include authenticated encryption and authenticated decryption (which may be collectively referred to as authenticated encryption). In some examples, authenticated encryption is a technique for assuring both the confidentiality and the authenticity of data. Authenticated encryption may be performed using an authenticated encryption algorithm (e.g., Advanced Encryption Standard Galois/Counter Mode (AES-GCM)). In some examples, an authenticated encryption algorithm, when used for authenticated encryption of data, produces as output encrypted data and a message authentication code (MAC) corresponding to the encrypted data (or the plaintext data). In some examples, the MAC may be referred to as a cryptographic result. In some examples, the MAC may be stored in one or more registers of a cryptographic hardware component and additionally or alternatively be stored in other storage of a computing device. In some examples, storing the MAC in the cryptographic hardware component and/or other storage of a computing device may be an example of performing a cryptographic action using a cryptographic result. In some examples, when the authenticated encryption algorithm is used for authenticated decryption, the encrypted data (or plaintext data) is used to generate a MAC (e.g., a cryptographic result), which is then compared a MAC previously generated for the data. In some examples, comparing the MAC with a previously generated MAC may be an example of performing a cryptographic action using a cryptographic result. If the MACs match, the data may be considered authenticated (e.g., an authentication check pass). If the MACs do not match, then the data is not authenticated (e.g., an authentication check failure). Authenticated encryption may be used for any data for which both encryption and authentication are desired. For example, when a computing device is to be hibernated (e.g., suspended), system state information from the memory of the computing device may be used as input for an authenticated encryption algorithm, so that the system state information is encrypted before being written to a storage device, and a MAC is generated corresponding to the encrypted system state information. Later, when the computing device is to be brought out of hibernation (e.g., restored), the authenticated encryption algorithm is again used to generate a MAC and decrypt the data. The MAC generated during the decryption process may be compared with the MAC generated during the encryption process to ensure the authenticity of the system state information.

In some examples, providing integrity verification or authenticated encryption using the processor of a computing device requires processor cycles that could otherwise be used to perform other operations, thereby reducing the performance of the device. Thus, examples described herein provide for a cryptographic hardware component configured to perform integrity verification or authenticated encryption, thereby offloading, at least in part, the services from the processor of a computing device. Using such a cryptographic hardware component for performing integrity verification or authenticated encryption may improve the performance of the computing device (e.g., by improving the time taken to perform a secure boot, improving the time take to restore a device from a hibernation state, allowing the processor of a computing device to perform other operations while the digests of data blocks are generated, etc.).

In some examples, the cryptographic hardware component is configured to execute integrity verification algorithms (e.g., the SHA family of algorithms) and an authenticated encryption algorithm (e.g., AES-GCM), and may be augmented to include hardware registers for storing at least a portion of the output of such algorithms. In some examples, for an integrity verification algorithm, the cryptographic hardware component includes hardware registers for storing digests corresponding to data for which integrity is being verified, as well as one or more error registers for storing an indication of an integrity check failure. In some examples, for an authenticated encryption algorithm, the cryptographic hardware component includes hardware registers for storing MACs corresponding to data that is being either encrypted or decrypted, and one or more error registers for storing an indication of an authentication check failure. In some examples, support for relevant cryptographic algorithms (e.g., SHA, AES-GCM, etc.) are added to a storage interface standard (e.g., JEDEC, etc.), in order to facilitate offloading of integrity verification and authenticated encryption to a cryptographic hardware component while remaining in compliance with the standard. For instance, support for one or more cryptographic algorithms (e.g., AES-GCM, SHA, etc.) may be added to the JDEC specification when implementing one or more examples described herein (e.g., where data from storage is processed by the cryptographic hardware component).

In some aspects, the one or more cryptographic services may additionally or alternatively include providing inline decryption of data (e.g., software images) that has been encrypted (e.g., on another computing device) prior to being stored on a storage device of a computing device. As an example, a software image may be encrypted using an encryption algorithm (e.g., AES-CBC, etc.) executed at a remote computing device. The encrypted software image may then be transmitted to a computing device, and stored on a storage device (e.g., a UFS device, etc.) of the computing device. In order to use the software image, the software image must be decrypted. However, decrypting the software image may require a cryptographic key and in some cases an initialization vector (IV). Thus, decrypting the software image may require moving the encrypted software image from the storage device to a memory device, where one or more processors execute an encryption algorithm to decrypt the data. Execution of the encryption algorithm may include generating the IV (e.g., using a sequence number (SN) of particular data blocks). Decrypting encrypted software images in such a manner consumes compute resources (e.g., processor cycles) of the computing device, which could, for example, be used for other operations.

Examples described herein address the use of such compute resources by offloading the decryption to a hardware cryptographic component, which provides inline decryption of encrypted software image data prior to the decrypted data being loaded into memory of the computing device. Specifically, the cryptographic hardware component may include one or more hardware storage components for storing the data items to perform the inline decryption. For example, the cryptographic key and the IV used to encrypt the data may be obtained from the device that encrypted the data and may be stored by the cryptographic hardware component, which allows the cryptographic hardware component to perform the inline decryption of the data before transferring the decrypted data to memory of the computing device. This may eliminate the need to use other compute resources (e.g., one or more processors) to decrypt the data after moving it to memory in an encrypted form. Obtaining the decrypted data may be referred to as obtaining a cryptographic result. Transferring the decrypted data to memory may be referred to as performing a cryptographic action using the cryptographic result.

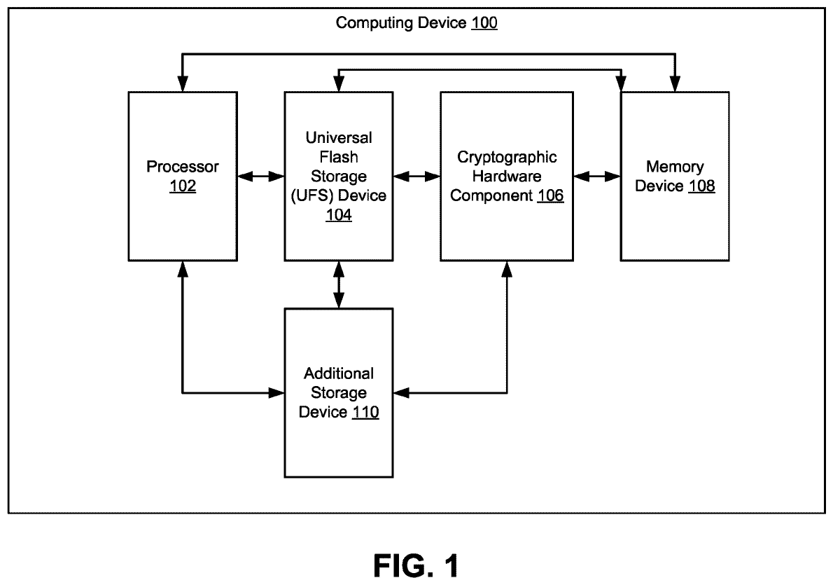

Various aspects of the techniques described herein will be discussed below with respect to the figures. FIG. 1 is a block diagram illustrating an example of a computing device 100. As shown, the computing device 100 includes a processor 102, a universal flash storage (UFS) device 104 a cryptographic hardware component 106, a memory device 108, and an additional storage device 110. Each of these components is described below.

The computing device 100 is any device, portion of a device, or any set of devices capable of electronically processing instructions and may include, but is not limited to, any of the following: one or more processors (e.g. components that include integrated circuitry, such as processor 102), memory (e.g., memory device 108) input and output device(s) (not shown), non-volatile storage hardware (e.g., UFS device 104, additional storage device 110), one or more physical interfaces, any number of other hardware components (not shown), and/or any combination thereof. Examples of computing devices include, but are not limited to, a mobile device (e.g., laptop computer, smart phone, personal digital assistant, tablet computer, automobile computing system, and/or any other mobile computing device), an Internet of Things (IoT) device, a server (e.g., a blade-server in a blade-server chassis, a rack server in a rack, etc.), a desktop computer, a storage device (e.g., a disk drive array, a fibre channel storage device, an Internet Small Computer Systems Interface (iSCSI) storage device, a tape storage device, a flash storage array, a network attached storage device, etc.), a network device (e.g., switch, router, multi-layer switch, etc.), a wearable device (e.g., a VR headset, an AR headset, AR glasses, a network-connected watch or smartwatch, or other wearable device), a robotic device, a television, and/or any other type of computing device with the aforementioned requirements. In one or more examples, any or all of the aforementioned examples may be combined to create a system of such devices, which may collectively be referred to as a computing device. Other types of computing devices may be used without departing from the scope of examples described herein.

In some examples, the processor 102 is any component that includes circuitry for executing instructions (e.g., of a computer program). As an example, such circuitry may be integrated circuitry implemented, at least in part, using transistors implementing such components as arithmetic logic units, control units, logic gates, registers, etc. In some examples, the processor may include additional components, such as, for example, cache memory. In some examples, a processor retrieves and decodes instructions, which are then executed. Execution of instructions may include operating on data, which may include reading and/or writing data. In some examples, the instructions and data used by a processor are stored in the memory (e.g., memory device 108) of the computing device 100. A processor may perform various operations for executing software, such as operating systems, applications, etc. The processor 102 may cause data to be written from memory to storage of the computing device 100 and/or cause data to be read from storage via the memory. Examples of processors include, but are not limited to, central processing units (CPUs), graphics processing units (GPUs), neural processing units, tensor processing units, data processing units (DPUs), digital signal processors (DSPs), etc. The processor 102 may be operatively connected to the memory device 108, and any storage (e.g., UFS device 104, additional storage device 110) of the computing device 100. As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection. Although FIG. 1 shows the computing device 100 having one processor 102, a computing device may have any number of processors without departing from the scope of examples described herein.

In some examples, the computing device 100 includes a UFS device 104. In some examples, the UFS device 104 is a flash storage device conforming to the UFS specification. The UFS device 104 may be used for storing data of any type. Data may be written to and/or read from the UFS device 104. As an example, the UFS device may store operating system images, software images, application data, etc. The UFS device 104 may store any other type of data without departing from the scope of examples described herein. In some examples, the UFS device 104 includes NAND flash storage. UFS device 104 may use any other type of storage technology without departing from the scope of examples described herein. In some examples, the UFS device 104 is capable of data rates that are relatively faster than other storage devices (e.g., additional storage device 110) of the computing device 100. The UFS device 104 may be operatively connected to the processor 102, the cryptographic hardware component 106, the memory device 108 and/or the additional storage device 110. Although FIG. 1 shows the computing device 100 having a single UFS device 104, the computing device may include any number of UFS devices without departing from the scope of examples described herein. Additionally, although FIG. 1 shows the UFS device 104, the computing device 100 may include any other type of flash storage device without departing from the scope of examples described herein.

In some examples, the computing device 100 includes an additional storage device 110. In some examples, the additional storage device is a non-volatile storage device. The additional storage device 110 may, for example, be a persistent memory device. In some examples, the additional storage device 110 may be computer storage of any type. Examples of type of computer storage include, but are not limited to, hard disk drives, solid state drives, flash storage, tape drives, removable disk drives, Universal Serial Bus (USB) storage devices, secure digital (SD) cards, optical storage devices, read-only memory devices, etc. Although FIG. 1 shows the additional storage device 110 as part of the computing device 100, the additional storage device may be separate from and operatively connected to the computing device 100 (e.g., an external drive array, cloud storage, etc.). In some examples, the additional storage device 110 operates at a data rate that is relatively slower than the UFS device 104. In some examples, the additional storage device 110 is also a UFS storage device. In some examples, the additional storage device 110 is operatively connected to the processor 102, the UFS device 104, the cryptographic hardware component 106, and/or the memory device 108. Although FIG. 1 shows the computing device 100 having a single additional storage device 110, the computing device 100 may have any number of additional storage devices without departing from the scope of examples described herein.

In some examples, the computing device 100 includes a memory device 108. The memory device may be any type of computer memory. In some examples, the memory device 108 is a volatile storage device. As an example, the memory device 108 may be random access memory (RAM). In one or more examples, data stored in the memory device 108 is located at memory addresses, and is thus accessible to the processor 102 using the memory addresses. Similarly, the processor 102 may write data to the memory device 108 using the memory addresses. The memory device 108 may be used to store any type of data, such as, for example, computer programs, the results of computations, etc. In some examples, the memory device 108 is operatively connected to the processor 102, the UFS device 104, the additional storage device 110, and/or the cryptographic hardware component 106. Although FIG. 1 shows the computing device 100 having a single memory device 108, the computing device 100 may have any number of memory devices without departing from the scope of examples described herein.

In some examples, the computing device 100 includes a cryptographic hardware component 106. The cryptographic hardware component may be any hardware component capable of performing various cryptographic services. In some examples, the cryptographic hardware component 106 is a sub-chip hardware component of a system on a chip (SoC), which may include other components shown in FIG. 1 such as, for example, the processor 102. Any other components of the computing device 100 may also be included as part of an SoC without departing from the scope of examples described herein. In some examples, the cryptographic hardware component 106 exists in a data path between storage devices (e.g., UFS storage device 104, additional storage device 110) and the memory device 108. As such, the cryptographic hardware component 106 may be considered an “inline” cryptographic hardware component. In some examples, the cryptographic hardware component 106 is configured to perform a variety of cryptographic service types on data being read from or written to a storage device (e.g., UFS device 104, additional storage device 110) of the computing device 100. In some examples, all data passing from memory to storage, or from storage to memory, of the computing device 100 passes through the cryptographic hardware component 106. In other examples, only a portion of the data passing from memory to storage, or from storage to memory, of the computing device 100 passes through the cryptographic hardware component 106. In some examples, the cryptographic hardware component is designed and configured to conform to one or more relevant industry standards (e.g., JEDEC). Support for one or more cryptographic algorithms (e.g., AES-GCM, SHA, etc.) may be added to the JDEC specification when implementing one or more examples described herein.

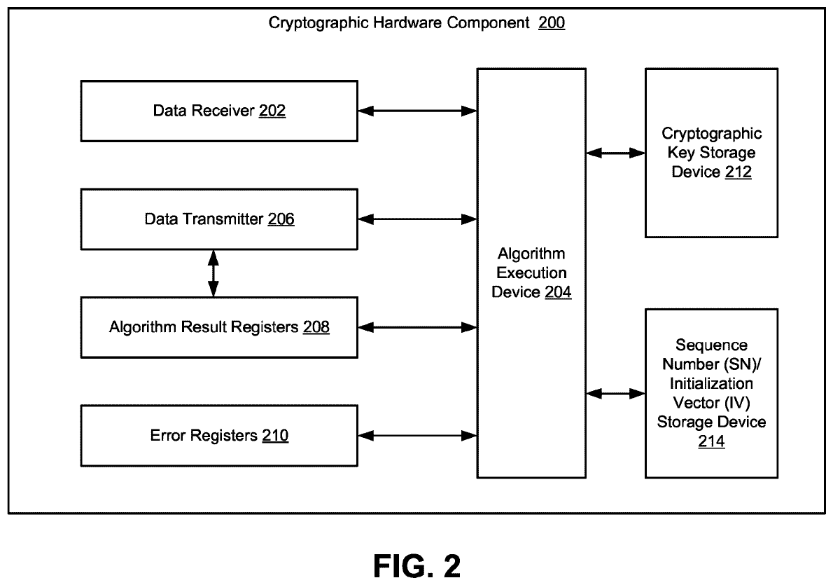

Examples of cryptographic service types that may be performed include, but are not limited to, encrypting data, decrypting data, performing data integrity verification, and performing authenticated encryption and decryption. In some examples, the cryptographic hardware component 106 is configured to perform the various cryptographic service types by being configured to execute one or more cryptographic algorithms. As an example, to perform encryption and decryption, the cryptographic hardware component 106 may be configured to execute one or more of the Advanced Encryption Standard XOR-encrypt-XOR Tweakable Block Ciphertext Stealing (AES-XTS) algorithm, the AES-Cypher Block Chaining (AES-CBC) algorithm, the AES-Electronic Codebook (AES-EBC) algorithm, the Encrypted Salt-Sector Initialization Vector-AES-CBC (ESSIV-AES-CBC) algorithm, etc., including any variants of such algorithms (e.g., 128, 192, 256, etc.). As another example, to perform integrity verification, the cryptographic hardware component 106 may be configured to execute a hash algorithm such as, for example, the one or more members of the SHA family of hash algorithms. As another example, to perform authenticated encryption, the cryptographic hardware component 106 may be configured to perform the AES-GCM algorithm. The cryptographic hardware component 106 may be configured to execute any other cryptographic algorithms without departing from the scope of examples described herein. In some examples, the cryptographic hardware component 106 is operatively connected to one or more storage devices (e.g., UFS device 104, additional storage device 110) and the memory device 108 of the computing device 100. Although FIG. 1 shows the computing device 100 having a single cryptographic hardware component 106, the computing device 100 may have any number of cryptographic hardware components without departing from the scope of examples described herein. The cryptographic hardware component is discussed further in the description of FIG. 2, below.

While FIG. 1 shows a certain number of components in a particular configuration, one of ordinary skill in the art will appreciate that the computing device 100 may include more components or fewer components, and/or components arranged in any number of alternate configurations without departing from the scope of examples described herein. Additionally, although not shown in FIG. 1, one of ordinary skill in the art will appreciate that the computing device 100 may, when powered on, execute any amount or type of software or firmware (e.g., bootloaders, operating systems, hypervisors, virtual machines, computer applications, mobile device apps, etc.). Accordingly, examples disclosed herein should not be limited to the configuration of components shown in FIG. 1.

FIG. 2 shows a block diagram of a cryptographic hardware component. In some examples, the cryptographic hardware component 200 is the same as the cryptographic hardware component 106 shown in FIG. 1 and described above. As shown in FIG. 2, the cryptographic hardware component 200 includes a data receiver 202, an algorithm execution device 204, a data transmitter 206, algorithm result registers 208, error registers 210, cryptographic key storage device 212, and a Sequence Number (SN)/Initialization Vector (IV) storage device 214. Each of these components is described below.

As discussed above in the description of FIG. 1, the cryptographic hardware component 200 is a hardware component that exists in a data path between one or more storage devices of a computing device and one or more memory devices of a computing device. In some examples, the cryptographic hardware component is a sub-chip of a SoC. In some examples, the cryptographic hardware component 200 is configured to provide various cryptographic service types for data passing between memory and storage of a computing device through the cryptographic hardware component 200.

In some examples, the cryptographic hardware component 200 includes a data receiver 202. The data receiver 202 may be any component capable of receiving data from other components of a computing device, such as storage and/or memory devices. As an example, the data receiver 202 may be a first-in-first-out (FIFO) buffer. In some examples, the data receiver 202 is configured to perform direct memory access (DMA). In some examples, the data receiver 202 is configured to receive data (e.g., from memory or storage), and provide the received data to an operatively connected algorithm execution device (discussed below). Although FIG. 2 shows the cryptographic hardware component with a single data receiver 202, the cryptographic hardware component may include any number of data receivers without departing from the scope of examples described herein.

In some examples, the cryptographic hardware component 200 includes an algorithm execution device 204. The algorithm execution device 204 may be any component or set of components configured to execute one or more cryptographic algorithms. As an example, the algorithm execution device 204 may include separate circuitry configured to execute one or more cryptographic algorithms each. As another example, the algorithm execution device 204 may include re-configurable circuitry (e.g., a field programmable gate array (FPGA)) capable of being configured to execute one or more cryptographic algorithms. In some examples, the algorithm execution device 204 is configured to provide encryption and decryption of data by executing any number of algorithms, such as AES-XTS, AES-ECB, AES-CBC, ESSIV-AES-CBC, etc. In some examples, the algorithm execution device 204 is configured to provide integrity verification via execution of a hashing algorithm (e.g., one or more members of the SHA family of hashing algorithms). In some examples, the algorithm execution device 204 is configured to provide authenticated encryption and/or decryption services via execution of one or more authenticated encryption algorithms (e.g., AES-GCM). In some examples, the algorithm execution device 204 is operatively connected to the data receiver 202, the data transmitter 206, the algorithm result registers 208, the error registers 210, and the cryptographic key storage device 212.

In some examples, the algorithm execution device 204 is configured to execute a hash function (e.g., of the SHA family) cryptographic service type as part of an integrity verification for data (e.g., during a secure boot process). In some examples, executing a hash algorithm includes receiving data (e.g., from data receiver 202) as input, and applying a mathematical hash function to the data to obtain an output of a digest of a fixed length, which may then be stored in one or more algorithm result registers 208 (discussed below) of the cryptographic hardware component 200. As an example, the data receiver 202 may obtain image data from a storage device (e.g., UFS device 104 shown in FIG. 1) during a secure boot process, and the data, or any portion thereof may be used as input for a hash function, and the output digest of the hash function may be stored in one or more of the algorithm result registers 208 of the cryptographic hardware component 200.

In some examples, the digest generated during integrity verification may be referred to as a cryptographic result. In some examples, to verify the integrity of data, a digest generated by the hash algorithm and stored in an algorithm result register 208 of the cryptographic hardware component 200 is compared with a previously generated digest for the data to determine whether the digest and the previously generated digest match. The previously generated digest may be obtained from any suitable location (e.g., stored in a hash table associated with the data, stored in another storge device of the computing device, etc.). In one or more examples, the comparison of the digest and the previously generated digest is performed by a component of the cryptographic hardware component 200. Alternatively, the comparison may be performed by another component of a computing device, such as a processor. In some examples, performing the comparison may be referred to as performing a cryptographic action. In some examples, if the digest and the previously generated digest match, then the integrity of the data corresponding to the digest is a pass, which represents at least a partial integrity check pass. In some examples, if the digest and the previously generated digest do not match, then the integrity check fails. In some examples, in the event of an integrity check failure, at least one of the error registers 210 (discussed below) is updated with an indication of the failure.

In some examples, the algorithm execution device 204 is configured to execute an authenticated encryption algorithm (e.g., AES-GCM) cryptographic service type when performing authenticated encryption (e.g., during a hibernate/suspend process) or authenticated decryption (e.g., during a resume from hibernation/suspend process).

In some examples, executing an authenticated encryption algorithm when performing authenticated encryption may include receiving data (e.g., from the data receiver 202) as input for the authenticated encryption algorithm, and executing the authenticated encryption algorithm to obtain encrypted data and a MAC corresponding to the data. The encryption and generation of the MAC may be performed in any number of ways. As an example, the input plaintext data may be encrypted, and then a hash function may be applied to the encrypted data to obtain a MAC corresponding to the encrypted data. As another example, the MAC may be generated by applying a hash function to the plaintext data, and then the plaintext data may be encrypted. As another example, the MAC may be generated by applying a hash function to the plaintext data, and then encrypting a combination of the plaintext data and the MAC. In some examples, the MAC is stored in one or more algorithm result registers 208 of the cryptographic hardware component 200. In some examples, the plaintext data to be encrypted is obtained from a memory device (e.g., RAM) of the computing device, and the encrypted data output from the authenticated encryption algorithm is stored in a storage device (e.g., a UFS device).

In some examples, executing an authenticated encryption algorithm when performing authenticated decryption may include receiving encrypted data (e.g., from the data receiver 202) as input for the authenticated encryption algorithm, and executing the authenticated encryption algorithm to obtain decrypted plaintext data and a MAC corresponding to the data. In some examples, the decryption and generation of the MAC are performed in a manner consistent with how the data was encrypted and the MAC was generated previously. For example, if the MAC was created using the encrypted data, then during the decryption, the MAC is again generated from the received encrypted data before the data is decrypted to obtain the plaintext data. In some examples, the MAC generated during the authenticated decryption is stored in the algorithm result registers 208 of the cryptographic hardware component. In some examples, the encrypted data is obtained from a storage device (e.g., the UFS storage device 104 shown in FIG. 1), and the decrypted plaintext data output from the authenticated encryption algorithm is transferred to a memory device (e.g., the memory device 108 shown in FIG. 1) of the computing device.

In some examples, the MAC and the encrypted data generated during an authenticated encryption may be referred to as a cryptographic result and is stored in the algorithm result registers 208. The MAC may then be transferred to other storage (e.g., persistent memory) for later comparison during an authenticated decryption. In some examples, storing the MACs in the registers and/or other storage may be referred to as performing a cryptographic action. In some examples, the MAC and the decrypted data generated by authenticated decryption may be referred to as a cryptographic result. In some examples, to verify the authenticity of the data, a MAC generated by an authenticated encryption algorithm during an authenticated decryption process and stored in the algorithm result registers 208 of the cryptographic hardware component 200 is compared with a MAC generated previously for the data during an authenticated encryption process. The previously generated MAC may be obtained from any suitable location (e.g., stored in another storge device of the computing device, etc.). In one or more examples, the comparison of the MAC and the previously generated MAC is performed by a component of the cryptographic hardware component 200. Alternatively, the comparison may be performed by another component of a computing device, such as a processor. In some examples, obtaining the previously generated MAC and performing the comparison may be referred to as performing a cryptographic action. In some examples, if the MAC and the previously generated MAC match, then the authenticity of the data corresponding to the MAC is a pass, which represents at least a partial authentication check pass. In some examples, if the MAC and the previously generated MAC do not match, then the authentication check fails. In some examples, in the event of an authentication check failure, at least one of the error registers 210 (discussed below) is updated with an indication of the failure.

In some examples, the cryptographic hardware component 200 is requested to perform a cryptographic service type (e.g., integrity verification, authenticated encryption, authenticated decryption, etc.). The request may be received from any suitable entity. As an example, the request may be received from a bootloader during a secure boot process. As another example, the request may be received from an operating system or other component or application when the computing device is to be suspended into a hibernation state, or resumed from a hibernation state. The request may be received in other ways (e.g., from an application, based on receiving data of a certain type or in a certain state, etc.). In some examples, the request determines (e.g., specifies) which cryptographic service algorithm is executed by the algorithm execution device 204. Although FIG. 1 shows the cryptographic hardware component 200 including a single algorithm execution device 204, the cryptographic hardware component may include any number of algorithm execution devices without departing from the scope of examples described herein.

In some examples, the cryptographic hardware component 200 includes a cryptographic key storage device 212. The cryptographic key storage device 212 may be any type of storage (see above description of FIG. 1). The cryptographic key storage device 212 may be a single storage device, or may be any number of separate storage components. In some examples, the cryptographic key storage device 212 is configured to store one or more cryptographic keys to be used when executing an authenticated encryption algorithm during an authenticated encryption, an authenticated decryption, and/or any other cryptographic service type. The cryptographic key storage device 212 may store any number of cryptographic keys, and each key may be of any length (e.g., 128 bits, 256 bits, 512 bits, etc.). In some examples, the cryptographic key storage device 212 is operatively connected to the algorithm execution device 204.

In some examples, the cryptographic hardware component 200 includes a SN/IV storage device 214. The SN/IV storage device 214 may be any type of storage (see above description of FIG. 1). The SN/IV storage device 214 may be a single storage device, or may be any number of separate storage components. In some examples, the SN/IV storage device 214 is configured to store one or more SNs (e.g., for performing inline encryption services) and/or one or more IVs (e.g., when performing inline decryption services). The SN/IV storage device 214 may store any number of SNs and/or IVs. Such SNs and IVs may be obtained using any technique. As an example, an IV corresponding to an encrypted software image stored in a storage device of a computing device may be received from a separate device that encrypted the software image. In some examples, the SN/IV storage device 214 is operatively connected to the algorithm execution device 204.

In some examples, the cryptographic hardware component 200 includes a data transmitter 206. The data transmitter 206 may be any component capable of receiving data from the algorithm execution device 204 and/or from the algorithm result registers 208. As an example, the data transmitter 206 may be a first-in-first-out (FIFO) buffer. In some examples, the data transmitter 206 is configured to perform direct memory access (DMA). In some examples, the data transmitter 206 is configured to receive transfer encrypted data to a storage device (e.g., a UFS storage device), to transfer decrypted data to a memory device (e.g., RAM), and/or to transfer a cryptographic result (e.g., a MAC, a digest, etc.) to another component (e.g., an additional storage device) of a computing device. In some examples, the data transmitter 206 is operatively connected to the algorithm execution device 204 and/or to the algorithm result registers 208. Although FIG. 2 shows the cryptographic hardware component with a single data transmitter 206, the cryptographic hardware component may include any number of data transmitter without departing from the scope of examples described herein.

In some examples, the cryptographic hardware component 200 includes any number of algorithm result registers 208. The algorithm result registers 208 may be hardware registers for storing at least a portion of a cryptographic result (e.g., a digest, a MAC, etc.). The algorithm result registers 208 may be configured to store data of any size (e.g., 128 bits, 256 bits, 512 bits, 1024 bits, 16 bytes, etc.). In some examples, the algorithm result registers 208 are operatively connected to the algorithm execution device 204 and/or the data transmitter 206.

In some examples, the cryptographic hardware component 200 includes any number of error registers 210. The error registers 210 may be hardware registers for storing an indication of either an integrity check failure or an authentication check failure. The error registers 210 may be of any size (e.g., 8 bits, 16 bits, etc.). In some examples, the error registers 210 are operatively connected to the algorithm execution device 204.

While FIG. 2 shows a certain number of components in a particular configuration, one of ordinary skill in the art will appreciate that the cryptographic hardware component 200 may include more components or fewer components, and/or components arranged in any number of alternate configurations without departing from the scope of examples described herein. Accordingly, examples disclosed herein should not be limited to the configuration of components shown in FIG. 1.

As discussed above, performing cryptographic service types, such as integrity verification and authenticated encryption, using the cryptographic hardware component 200, and storing cryptographic results obtained therefrom in hardware registers of the cryptographic hardware component 200 effectively offloads the operations from the one or more processors of a computing device. As such, the offloading of cryptographic algorithm execution improves the performance of the computing device whenever storage operations (e.g., reading data from storage, writing data to storage) need the security enhancement provided by integrity verification and authenticated encryption. Examples of improved performance include, but are not limited to: improved key performance indicators (e.g., improved boot time) seen when performing integrity checking during a secure boot process; allowing processes such as Linux device-mapper (dm) verity (dm-verity) integrity verification of block storage devices to be performed by the cryptographic hardware component 200 thereby allowing the other compute resources (e.g., a processor) of a computing device to perform other operations; and allowing compute resources of a computing device to perform other operations during authenticated encryption and decryption operations (e.g., performed during a suspend or resume process). As an example, if 1.5 gigabytes (GB) of data in the memory of a computing device need to be captured and written to storage during a suspend process, and the block size of the data is four kilobytes (KB) then there are 384,000 blocks of data, each of which, without the examples described herein, would have to be operated on by the one or more processors of the computing device to provide authenticated encryption (e.g., data encryption and MAC generation) of the data. However, the examples described herein allow all of the operations to instead be performed in the cryptographic hardware component, thereby allowing the one or more processors to perform other operations, which may improve the amount of time needed to put the computing device into a state of hibernation.

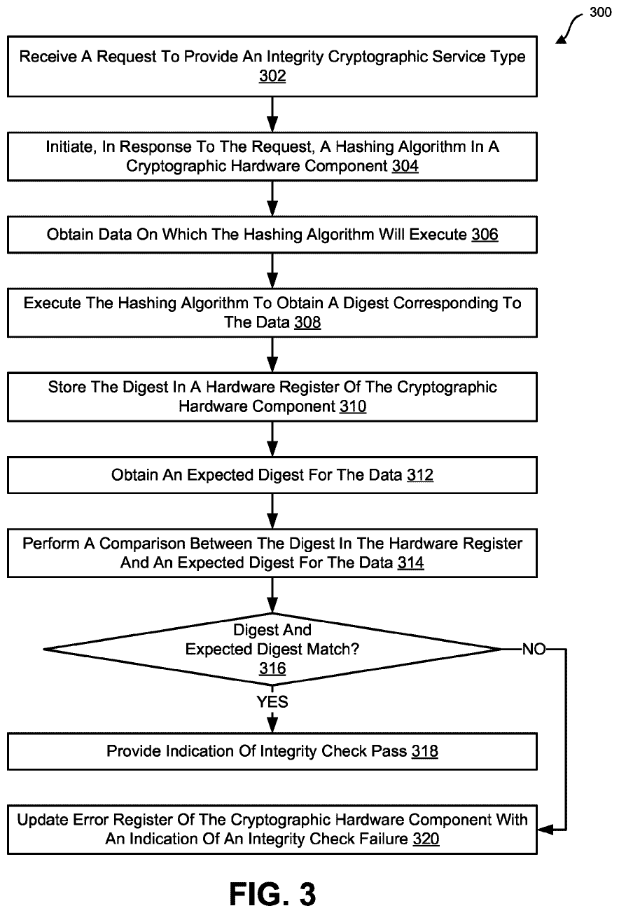

FIG. 3 is a flow diagram illustrating an example of a process 300 for performing an integrity verification process using a hash algorithm in accordance with examples described herein. The process 300 may be performed, at least in part, for example, by a cryptographic hardware component such as the cryptographic hardware component 106 shown in FIG. 1 and the cryptographic hardware component 200 shown in FIG. 2.

At block 302, the process 300 includes receiving, a request to provide an integrity cryptographic service type. In some examples, the request is received by a cryptographic hardware component (e.g., the cryptographic hardware component 200 shown in FIG. 2 and described above). In some examples, the request is received from any entity (e.g., hardware, software, firmware, or any combination thereof) seeking to perform integrity verification for previously stored data. As an example, when performing a secure boot of an operating system on a computing device, a bootloader may request integrity verification of the operating system image. As another example, an operating system, via a processor, may request integrity verification of previously stored data in order to help ensure that loading the data into memory does not pose a security risk for a computing device to be compromised in some way. In some examples, the request specifies an algorithm to be executed that the cryptographic hardware component is configured to execute (e.g., using the algorithm execution device 204 shown in FIG. 2 and described above). In some examples, the cryptographic algorithm specified in the request is the same as the algorithm used previously on the data. As an example, data may have previously had a hash generated using a SHA family algorithm, and the request may specify the same SHA family algorithm to be executed by the cryptographic hardware component so that the resulting digest (e.g., a cryptographic result) may be compared with the previously generated digest for the same data, which may be included, for example, in a hash table containing hashes for various segments of the data. In some examples, comparing the digest with a previously generated digest may be referred to as performing a cryptographic action.

At block 304, the process 300 includes initiating, in response to the request, a hashing algorithm. In some examples, the hashing algorithm is executed using an algorithm execution device (e.g., the algorithm execution device 204 shown in FIG. 2) of a cryptographic hardware component (e.g., the cryptographic hardware component 200 shown in FIG. 2). In some examples, initiating the execution of a hashing algorithm includes configuring hardware (e.g., circuitry), software, or a combination thereof of the algorithm execution device to execute the hashing algorithm specified in the request received in block 302.

At block 306 the process 300 includes obtaining the data on which the hashing algorithm will execute. As an example, the data may be received at a data receiver (e.g., data receiver 202 shown in FIG. 2) of a cryptographic hardware component (e.g., the cryptographic hardware component 200 shown in FIG. 2), and from there provided to an algorithm execution device (e.g., algorithm execution device 204 shown in FIG. 2). The data may be obtained from any storage device (e.g., the UFS device 104 shown in FIG. 1, the additional storage device 110 shown in FIG. 1, etc.) of a computing device. In some examples, the data on which the hashing algorithm will operate is a portion of the data for which integrity verification is requested. As such, the data may be received in a series of discrete units (e.g., blocks, segments, etc.), and each such discrete unit of data may be used as input to the hashing algorithm separately to produce a set of digests for the data as a whole.

At block 308, the process 300 includes executing the hashing algorithm using the data obtained in block 306 as input to generate a digest corresponding to the data. As an example, an algorithm execution device (e.g., the algorithm execution device 204 shown in FIG. 2) may execute the hashing algorithm using the data. In some examples, executing the hash algorithm includes executing a hash function. In some examples, executing a hash function includes inputting the data into the hash function to obtain the digest as output. In some examples, the digest is of a fixed size regardless of the size of the input data. In some examples, the fixed size of the digest is dictated by the particular hashing algorithm being executed. Any hash function may be executed without departing from the scope of examples described herein, and the particular hash function executed is dictated by the hashing algorithm being executed. As an example, when the hashing algorithm SHA-256 is being executed, the digest size will be 256 bits, and the hash function generating the digest may append a binary digit to the binary string representing the input data, pad the data with additional zeros, append a binary representation of an integer representing the length of the input data, create a set of initial hash values, create a set of constants, create a message schedule using the data, perform a series of rotations and logic operations, compress the result to the correct size, and perform some additional final modifications, thereby obtaining the digest corresponding to the input data.

At block 310, the process 300 includes storing the digest obtained as output from the hashing algorithm executed in block 308 in a hardware register. As an example, the digest may be stored in a hardware register (e.g., one of the algorithm result registers 208 shown in FIG. 2) of a cryptographic hardware component (e.g., the cryptographic hardware component 200 shown in FIG. 2).

At block 312, the process 300 includes obtaining an expected digest for the data. As an example, an expected digest for the data may be stored in a hash table associated with the data. As another example, the expected digest may be obtained from a storage device (e.g., the UFS device 104 shown in FIG. 1, the additional storage device 110 shown in FIG. 1) of a computing device. In some examples, the expected digest is obtained by the cryptographic hardware component, or by any other component of a computing device that will be comparing the output digest and the expected digest.

At block 314, the process 300 includes performing a comparison between the digest stored in the hardware register of the cryptographic hardware component with the expected digest obtained in block 312. In some examples, performing the comparison includes determining whether any differences exist between the digest in the hardware register and the expected digest. A digest corresponding to a particular data item is very likely to be unique, meaning that the chance of two different data items corresponding to the same digest (e.g., a hash collision) is very small. Additionally, even small changes to the data cause the digest to change significantly. Therefore, if the digest and the expected digest match, it is likely that the data for which integrity verification is desired has not been altered since it was previously stored (e.g., the integrity of the data is verified). Integrity verification may thus improve the security of a computing device by ensuring that no change, malicious or otherwise, was made to the stored data.

At block 316, the process 300 includes making a determination as to whether the digest and the expected digest match. As an example, the cryptographic hardware component (e.g., the cryptographic hardware component 200 shown in FIG. 2), or a different component of a computing device may use the digest from the hardware register of the cryptographic hardware component and the expected digest to make the determination. In some examples, the digest and the expected digest match if the digest and the expected digest are identical. In some examples, when the digest and the expected digest match, then at least a partial integrity check pass occurs. The integrity check pass may be partial in instances where there are additional data units for which data integrity must be verified to obtain a full integrity check pass, with each other data unit being subjected to the process 300. In some examples, if the digest and the expected digest are not identical, then the integrity check fails, and the integrity of the data is not verified. In some examples, when the determination is of an integrity check failure, the process 300 continues to block 320. In some examples, when the determination is of an integrity check pass, the process 300 continues to block 318.

At block 318, the process 300 includes providing an indication of the integrity check pass. As an example, the component (e.g., the cryptographic hardware component 200 shown in FIG. 2) that performed the comparison of the digest and the expected digest may provide an indication of the integrity check pass to the entity that requested the cryptographic hardware component to execute the hashing algorithm in block 302. In some examples, the integrity check pass indication allows for the data for which the integrity was verified to be transferred from a storage device (e.g., the UFS device 104 shown in FIG. 1, the additional storage device 110 shown in FIG. 1) to memory (e.g., the memory device 108 shown in FIG. 1) of a computing device, where the data may be otherwise operated on to continue performing a process (e.g., secure boot process).

At block 320, the process 300 includes updating an error register of the cryptographic hardware component with an indication of the integrity check failure. As an example, the cryptographic hardware component 200 shown in FIG. 2 may update one of the error registers 210 shown in FIG. 1 with an indication of the integrity check failure. The indication may be of any form without departing from the scope of examples described herein. As an example, the state of one or more bits of the error register may be changed, thereby indicating an integrity check failure.

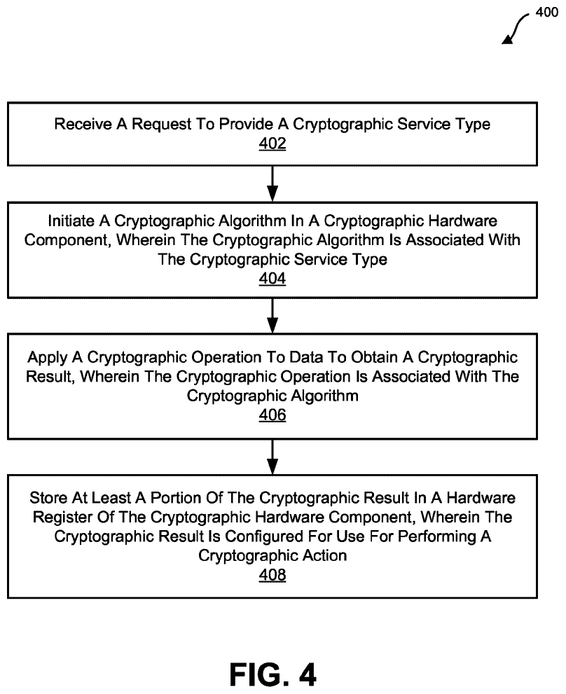

FIG. 4 is a flow diagram illustrating an example of a process 400 for performing an authenticated encryption process using an authenticated encryption algorithm in accordance with examples described herein. The process 400 may be performed, at least in part, for example, by a cryptographic hardware component such as the cryptographic hardware component 106 shown in FIG. 1 and the cryptographic hardware component 200 shown in FIG. 2.

At block 402, the process 400 includes receiving a request to provide a cryptographic service type. In some examples, the request is received by a cryptographic hardware component (e.g., the cryptographic hardware component 200 shown in FIG. 2 and described above). In some examples, the request is received from any entity (e.g., hardware, software, firmware, or any combination thereof) seeking to perform integrity verification for previously stored data. The cryptographic service type requested may be any other cryptographic service system (e.g., authenticated encryption, authenticated decryption, etc.) without departing from the scope of examples described herein.

At block 404, the process 400 includes initiating a cryptographic algorithm in a cryptographic hardware component, wherein the cryptographic algorithm is associated with the cryptographic service type. In some examples, the cryptographic algorithm is executed using an algorithm execution device (e.g., the algorithm execution device 204 shown in FIG. 2) of a cryptographic hardware component (e.g., the cryptographic hardware component 200 shown in FIG. 2). Examples of cryptographic algorithms include, but are not limited to, SHA, AES-GCM, AES-XTS, AES-ECB, AES-CBC, and ESSIV-AES-CBC. Other cryptographic algorithms may be initiated without departing from the scope of examples described herein.

At block 406, the process 400 includes applying a cryptographic operation to data to obtain a cryptographic result, wherein the cryptographic operation is associated with the cryptographic algorithm. In some examples, the cryptographic operation is applied by a cryptographic hardware component (e.g., the cryptographic hardware component 200 shown in FIG. 2 and described above). Examples of a cryptographic result include, but are not limited to, a digest, a MAC, encrypted data, decrypted data, etc.

At block 408, the process 400 includes storing at least a portion of the cryptographic result in a hardware register (e.g., the algorithm results registers 208 of FIG. 2) of the cryptographic hardware component (e.g., the cryptographic hardware component 200 of FIG. 2), wherein the cryptographic result is configured for use for performing a cryptographic action. Examples of cryptographic actions include, but are not limited to, storing digests, performing comparisons between digests and expected digests, providing an indication of an integrity check pass, updating an error register (e.g., error registers 210 of FIG. 2) with an indication of an integrity check failure, storing MACs in hardware registers, storing MACs in storage devices, storing encrypted data in a storage device, performing comparisons between Macs and expected MACs, providing an indication of an authenticated decryption pass, updating an error register with an indication of an authenticated decryption failure, storing decrypted data in a memory device, etc.

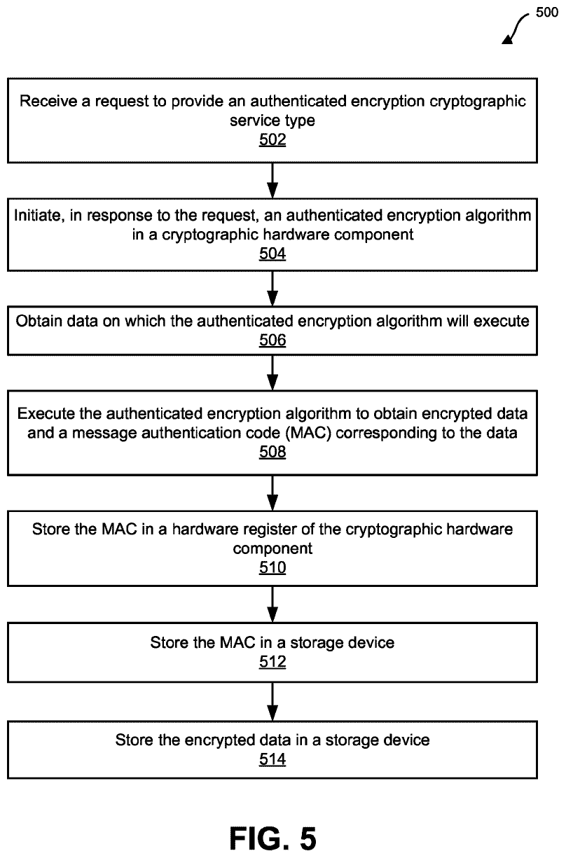

FIG. 5 is a flow diagram illustrating another example of a process 500 for performing an authenticated encryption process using an authenticated encryption algorithm in accordance with examples described herein. The process 500 may be performed, at least in part, for example, by a cryptographic hardware component such as the cryptographic hardware component 106 shown in FIG. 1 and the cryptographic hardware component 200 shown in FIG. 2.

At block 502, the process 500 includes receiving a request to provide an authenticated encryption cryptographic service type. In some examples, the request is received by a cryptographic hardware component (e.g., the cryptographic hardware component 200 shown in FIG. 2 and described above). In some examples, the request is received from any entity (e.g., hardware, software, firmware, or any combination thereof) seeking to perform authenticated encryption of data for any purpose. As an example, when a computing device is to be suspended to a state of hibernation, certain system state information from the memory (e.g., the memory device 108 shown in FIG. 2) and/or other data storage (e.g., storage devices, registers, etc.) of the computing device is written to storage (e.g., the UFS storage device 104 shown in FIG. 1, the additional storage device 110 shown in FIG. 1). In some examples, in order to help ensure the security of the computing device at a later time when the device is resumed from the hibernation state, the system state information may be encrypted and a MAC may be generated for later use in authenticating the data. The encrypted data and the MAC may be considered as portions of a cryptographic result. In some examples, the request specifies an algorithm that the cryptographic hardware component is configured to execute (e.g., using the algorithm execution device 204 shown in FIG. 2 and described above). As an example, the request may specify the use of AES-GCM to perform the authenticated encryption.

At block 504, the process 500 includes initiating, in response to the request, an authenticated encryption algorithm. In some examples, the authenticated encryption algorithm is executed using an algorithm execution device (e.g., the algorithm execution device 204 shown in FIG. 2) of a cryptographic hardware component (e.g., the cryptographic hardware component 200 shown in FIG. 2). In some examples, initiating the execution of an authenticated encryption algorithm includes configuring hardware (e.g., circuitry), software, or a combination thereof of the algorithm execution device to execute the authenticated encryption algorithm specified in the request received in block 302.

At block 506 the process 500 includes obtaining the data on which the authenticated encryption algorithm will execute. As an example, the data may be received at a data receiver (e.g., data receiver 202 shown in FIG. 2) of a cryptographic hardware component (e.g., the cryptographic hardware component 200 shown in FIG. 2), and from there provided to an algorithm execution device (e.g., algorithm execution device 204 shown in FIG. 2). The data may be obtained from any data location on the computing device (e.g., the memory device 108 shown in FIG. 1, the UFS device 104 shown in FIG. 1, the additional storage device 110 shown in FIG. 1, registers, etc.). In some examples, the data on which the authenticated encryption algorithm will operate is a portion of the data for which authenticated encryption is requested. As such, the data may be received in a series of discrete units (e.g., blocks, segments, etc.), and each such discrete unit of data may be used as input to the authenticated encryption algorithm separately to produce a set of MACs for the data, as well as the encrypted data.

At block 508, the process 500 includes executing the authenticated encryption algorithm using the data obtained in block 506 as input to generate encrypted data and a MAC corresponding to the encrypted data, or the plaintext data, depending on the particular authenticated encryption algorithm being executed. As an example, a user may seek to hibernate a computing device, or the computing device may be configured to hibernate after a period of inactivity or in response to low battery power. In such a scenario, the operating system of the computing device may request authenticated encryption for the data currently in the memory of the device, which is used as input for the authenticated encryption algorithm specified in the request received in block 502. In some examples, executing the authenticated encryption algorithm generates as output encrypted data and a MAC corresponding to the data or to the encrypted data (e.g., a cryptographic result). In some examples, a cryptographic key (e.g., obtained from the cryptographic key storage device 212 shown in FIG. 2) is used to encrypt the data. The same key, or a different key, may be used when generating the MAC (which may also be referred to as an authentication tag). In some examples, executing the authenticated encryption algorithm includes using and/or generating other items of information, such as, for example, an initialization vector, additional authenticated data, the value of one or more counters, etc.

At block 510, the process 500 includes storing the MAC obtained as output from the authenticated encryption algorithm executed in block 508 in a hardware register. As an example, the MAC may be stored in a hardware register (e.g., one of the algorithm result registers 208 shown in FIG. 2) of a cryptographic hardware component (e.g., the cryptographic hardware component 200 shown in FIG. 2). In some examples, storing the MAC in a hardware register may be at least a portion of performing a cryptographic action.

At block 512, the process 500 includes storing the MAC obtained as output from the authenticated encryption algorithm executed in block 508 in a storage device. As an example, the MAC may be stored in a storage device, such as persistent memory or any other storage device (e.g., the UFS device 104 shown in FIG. 1, the additional storage device 110 shown in FIG. 1). In some examples, the MAC is transferred from a hardware register of the cryptographic hardware component (e.g., the cryptographic hardware component 200 shown in FIG. 2) to the storage device. In some examples, storing the MAC in a storage device may be referred to as performing at least a portion of a cryptographic action. In some examples, the MAC is used later as an expected MAC when performing an authenticated decryption of the data.

At block 514, the process 500 includes storing the encrypted data obtained as output from the authenticated encryption algorithm executed in block 508 in a storage device (e.g., the UFS device 104 shown in FIG. 1, the additional storage device 110 shown in FIG. 1). In some examples, the encrypted data is used later when an authenticated decryption is requested for the data (e.g., during a resume process). In some examples, storing the encrypted data in a storage device may be referred to as performing at least a portion of a cryptographic action.

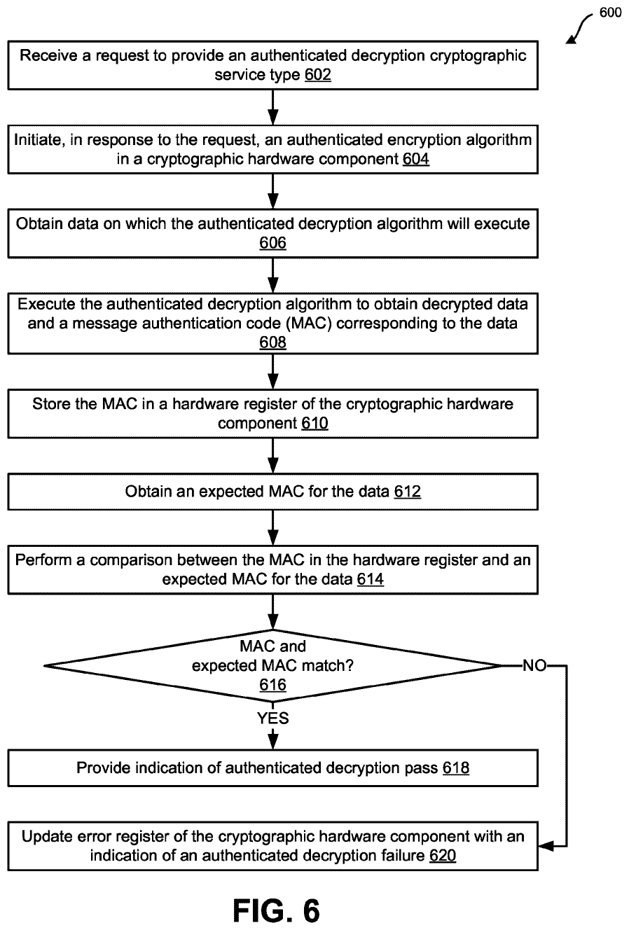

FIG. 6 is a flow diagram illustrating an example of a process 600 for performing an authenticated decryption process using an authenticated encryption algorithm in accordance with examples described herein. The process 600 may be performed, at least in part, for example, by a cryptographic hardware component such as the cryptographic hardware component 106 shown in FIG. 1 and the cryptographic hardware component 200 shown in FIG. 2.

At block 602, the process 600 includes receiving a request to provide an authenticated decryption cryptographic service type. In some examples, the request is received by a cryptographic hardware component (e.g., the cryptographic hardware component 200 shown in FIG. 2 and described above). In some examples, the request is received from any entity (e.g., hardware, software, firmware, or any combination thereof) seeking to perform authenticated decryption of data for any purpose. As an example, when a computing device has been suspended to a state of hibernation, certain system state information from the memory (e.g., the memory device 108 shown in FIG. 2) and/or other data storage (e.g., storage devices, registers, etc.) of the computing device is written to storage (e.g., the UFS storage device 104 shown in FIG. 1, the additional storage device 110 shown in FIG. 1) as encrypted data, and a MAC is generated corresponding to the data. In such a scenario, when the computing device is to resume operation, a request may be received to provide authenticated decryption, which includes decrypting the encrypted data, generating a MAC corresponding to the data, and verifying that the MAC generated during the authenticated encryption, and the MAC generated during the decryption match thereby authenticating the data. The decrypted data and the MAC may be considered as portions of a cryptographic result. In some examples, the request specifies an algorithm to be executed that the cryptographic hardware component is configured to execute (e.g., using the algorithm execution device 204 shown in FIG. 2 and described above). As an example, the request may specify the use of AES-GCM to perform the authenticated decryption. In some examples, the authenticated encryption algorithm used to perform the authenticated decryption corresponds to the authenticated encryption algorithm used previously to perform authenticated encryption for the data.

At block 604, the process 600 includes initiating, in response to the request, an authenticated encryption algorithm. In some examples, the authenticated encryption algorithm is executed using an algorithm execution device (e.g., the algorithm execution device 204 shown in FIG. 2) of a cryptographic hardware component (e.g., the cryptographic hardware component 200 shown in FIG. 2). In some examples, initiating the execution of an authenticated encryption algorithm includes configuring hardware (e.g., circuitry), software, or a combination thereof of the algorithm execution device to execute the authenticated encryption algorithm specified in the request received in block 602.

At block 606 the process 600 includes obtaining the data on which the authenticated encryption algorithm will execute. As an example, the data may be received at a data receiver (e.g., data receiver 202 shown in FIG. 2) of a cryptographic hardware component (e.g., the cryptographic hardware component 200 shown in FIG. 2), and from there provided to an algorithm execution device (e.g., algorithm execution device 204 shown in FIG. 2). The data may be obtained from any storage device (e.g., the UFS device 104 shown in FIG. 1, the additional storage device 110 shown in FIG. 1, etc.). In some examples, the data on which the authenticated encryption algorithm will operate is a portion of the data for which authenticated decryption is requested. As such, the data may be received in a series of discrete units (e.g., blocks, segments, etc.), and each such discrete unit of data may be used as input to the authenticated decryption algorithm separately to produce a set of MACs for the data as a whole.

At block 608, the process 600 includes executing the authenticated encryption algorithm using the data obtained in block 506 as input to generate decrypted data and a MAC corresponding to the decrypted data, or the plaintext data, depending on the particular authenticated encryption algorithm being executed. Generating decrypted data and/or a MAC may be referred to as obtaining a cryptographic result. As an example, a user may seek to resume a computing device from a hibernation state. In such a scenario, the operating system, or any other component, of the computing device may request authenticated decryption for the data currently in a storage device (e.g., the UFS device 104 shown in FIG. 1, the additional storage device 110 shown in FIG. 1) of the computing device, which is used as input for the authenticated encryption algorithm specified in the request received in block 602. In some examples, executing the authenticated encryption algorithm generates as output decrypted data and a MAC corresponding to the data or to the encrypted data. In some examples, a cryptographic key (e.g., obtained from the cryptographic key storage device 212 shown in FIG. 2) is used to decrypt the data. The same key, or a different key, may be used when generating the MAC (which may also be referred to as an authentication tag). In some examples, executing the authenticated encryption algorithm includes using and/or generating other items of information, such as, for example, an initialization vector, additional authenticated data, the value of one or more counters, etc.

At block 610, the process 600 includes storing the MAC obtained as output from the authenticated encryption algorithm executed in block 608 in a hardware register. As an example, the MAC may be stored in a hardware register (e.g., one of the algorithm result registers 208 shown in FIG. 2) of a cryptographic hardware component (e.g., the cryptographic hardware component 200 shown in FIG. 2). In some examples, storing the MAC may be referred to as performing at least a portion of a cryptographic action.

At block 612, the process 600 includes obtaining an expected MAC for the data. As an example, the expected MAC for the data may be stored in some form of persistent memory of a computing device. As another example, the expected MAC may be obtained from a storage device (e.g., the UFS device 104 shown in FIG. 1, the additional storage device 110 shown in FIG. 1) of a computing device. In some examples, the expected MAC is obtained by the cryptographic hardware component, or by any other component of a computing device that will be comparing the output MAC and the expected MAC. In some examples, obtaining an expected MAC may be referred to as performing at least a portion of a cryptographic action.

At block 614, the process 600 includes performing a comparison between the MAC stored in the hardware register of the cryptographic hardware component with the expected MAC obtained in block 612. In some examples, performing the comparison may be referred to as performing at least a portion of a cryptographic action. In some examples, performing the comparison includes determining whether any differences exist between the MAC in the hardware register and the expected MAC. A MAC corresponding to a particular data item is very likely to be unique, meaning that the chance of two different data items corresponding to the same MAC is very small. Additionally, even small changes to the data cause the MAC to change significantly. Therefore, if the MAC and the expected MAC match, it is likely that the data for which authenticated decryption is desired has not been altered since it was previously stored (e.g., the authenticity of the data is verified). Authenticated decryption may thus improve the security of a computing device by ensuring that no change, malicious or otherwise, was made to the stored data.

At block 616, the process 600 includes making a determination as to whether the MAC and the expected MAC match, which may be referred to as performing at least a portion of a cryptographic action. As an example, the cryptographic hardware component (e.g., the cryptographic hardware component 200 shown in FIG. 2), or a different component of a computing device may use the MAC from the hardware register of the cryptographic hardware component and the expected MAC to make the determination. In some examples, the MAC and the expected MAC match if the MAC and the expected MAC are identical. In some examples, when the MAC and the expected MAC match, then at least a partial authentication check pass occurs. The authentication check pass may be partial in instances where there are additional data units for which data authenticity must be verified to obtain a full authenticity check pass, with each other data unit being subjected to the process 600. In some examples, if the MAC and the expected MAC are not identical, then the authentication check fails, and the authenticity of the data is not verified. In some examples, when the determination is of an authentication check failure, the process 600 continues to block 620. In some examples, when the determination is of an authentication check pass, the process 600 continues to block 618.

At block 618, the process 600 includes providing an indication of the authentication check pass, which may be referred to as performing at least a portion of a cryptographic action. As an example, the component (e.g., the cryptographic hardware component 200 shown in FIG. 2) that performed the comparison of the MAC and the expected MAC may provide an indication of the authentication check pass to the entity that requested the cryptographic hardware component to execute the authenticated encryption algorithm in block 602. In some examples, the authentication check pass indication allows for the data for which the authenticity was verified to be transferred from a storage device (e.g., the UFS device 104 shown in FIG. 1, the additional storage device 110 shown in FIG. 1) to memory (e.g., the memory device 108 shown in FIG. 1) of a computing device, where the data may be otherwise operated on.

At block 620, the process 600 includes updating an error register of the cryptographic hardware component with an indication of the authentication check failure, which may be referred to as performing at least a portion of a cryptographic action. As an example, the cryptographic hardware component 200 shown in FIG. 2 may update one of the error registers 210 shown in FIG. 1 with an indication of the authentication check failure. The indication may be of any form without departing from the scope of examples described herein. As an example, the state of one or more bits of the error register may be changed, thereby indicating an authentication check failure.

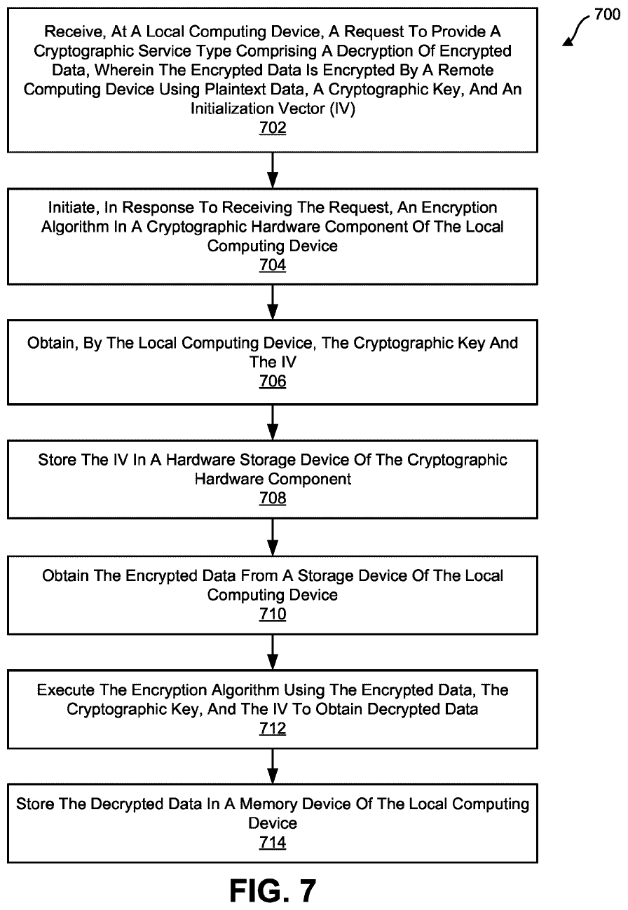

FIG. 7 is a flow diagram illustrating an example of a process 700 for performing a decryption process using an encryption algorithm in accordance with examples described herein. The process 700 may be performed, at least in part, for example, by a cryptographic hardware component such as the cryptographic hardware component 106 shown in FIG. 1 and the cryptographic hardware component 200 shown in FIG. 2.

At block 702, the process 700 includes receiving, at a local computing device (e.g., computing device 100 of FIG. 1), a request to provide a cryptographic service type comprising a decryption of encrypted data, wherein the encrypted data is encrypted by a remote computing device using plaintext data, a cryptographic key, and an initialization vector (IV). In some examples, the request is received by a cryptographic hardware component (e.g., the cryptographic hardware component 200 shown in FIG. 2 and described above). In some examples, the request is received from any entity (e.g., hardware, software, firmware, or any combination thereof) seeking to perform decryption of data for any purpose. As an example, a software image (or any other type of data) may have been encrypted by a remote computing device (e.g., a server) prior to be stored on a storage device of a local computing device (e.g., a mobile computing device). In such a scenario, the encryption may be performed pursuant to any of the AES type encryption algorithms (e.g., CBC, GCM, etc.), which encrypt data, at least in part, using a cryptographic key and an IV. Accordingly, decrypting the data, at least in part, uses the same key and IV used during the encryption process.

At block 704, the process 700 includes initiating, in response to receiving the request, an encryption algorithm in a cryptographic hardware component of the local computing device. In some examples, the encryption algorithm is executed using an algorithm execution device (e.g., the algorithm execution device 204 shown in FIG. 2) of a cryptographic hardware component (e.g., the cryptographic hardware component 200 shown in FIG. 2). In some examples, initiating the execution of an encryption algorithm includes configuring hardware (e.g., circuitry), software, or a combination thereof of the algorithm execution device to execute the encryption algorithm specified in the request received in block 802.

At block 706, the process 700 includes obtaining, by the local computing device (e.g., the computing device 100 of FIG. 1), the cryptographic key and the IV. The key and IV may be obtained using any appropriate technique. As an example, the key may be obtained using any suitable key derivation and/or exchange procedure between the remote device where the data was encrypted, and the local device having the cryptographic hardware component (e.g., the cryptographic hardware component 200 shown in FIG. 2) and storing the encrypted data. As another example, the IV may be transmitted from the remote device to the local device where the encrypted data is stored.

At block 708, the process 700 includes storing the IV in a hardware storage device of the cryptographic hardware component (e.g., the cryptographic hardware component 200 of FIG. 2).

At block 710, the process 700 includes obtaining the encrypted data (e.g., a software image encrypted by a remote computing device) from a storage device of the local computing device. As an example, the encrypted data may be received at a data receiver (e.g., data receiver 202 shown in FIG. 2) of a cryptographic hardware component (e.g., the cryptographic hardware component 200 shown in FIG. 2), and from there provided to an algorithm execution device (e.g., algorithm execution device 204 shown in FIG. 2). The data may be obtained from any storage device (e.g., the UFS device 104 shown in FIG. 1, the additional storage device 110 shown in FIG. 1, etc.). In some examples, the data on which the encryption algorithm will operate is a portion of the data for which decryption is requested. As such, the data may be received in a series of discrete units (e.g., blocks, segments, etc.), and each such discrete unit of data may be used as input to the decryption algorithm separately to decrypt the encrypted data as a whole.

At block 712, the process 700 includes executing the encryption algorithm using the encrypted data, the cryptographic key, and the IV to obtain decrypted data. As an example, the cryptographic hardware component 200 shown in FIG. 2 may execute the encryption algorithm using the encrypted data, and the key and IV stored by the cryptographic hardware component in block 810 to obtain decrypted data.

At block 714, the process 700 includes storing the decrypted data in a memory device (e.g., memory device 108 of FIG. 1) of the local computing device (e.g., the computing device 100 of FIG. 1). In some examples, the decryption may be considered inline decryption. As such the decryption may, for example, be performed sequentially on discrete portions of the encrypted data as it is transferred from a storage device to the one or more memory devices.

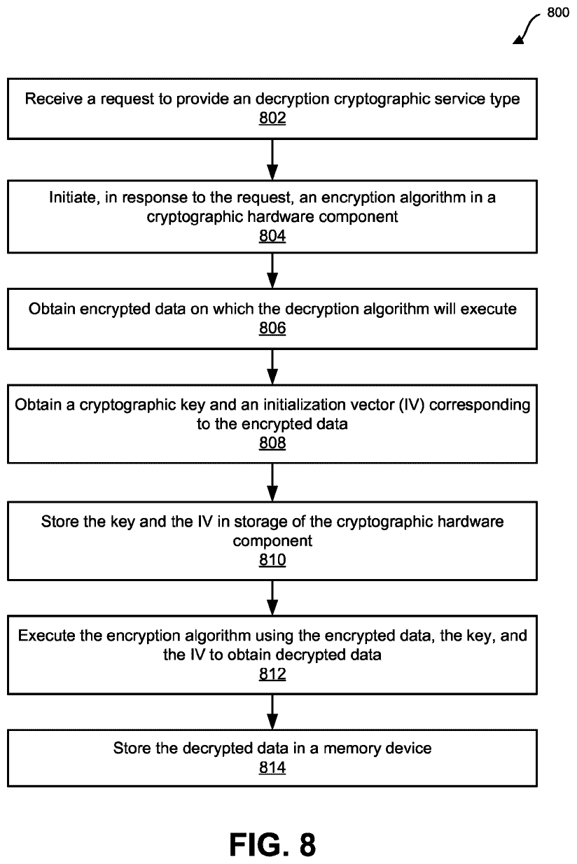

FIG. 8 is a flow diagram illustrating an example of a process 800 for performing a decryption process using an encryption algorithm in accordance with examples described herein. The process 800 may be performed, at least in part, for example, by a cryptographic hardware component such as the cryptographic hardware component 106 shown in FIG. 1 and the cryptographic hardware component 200 shown in FIG. 2.

At block 802, the process 800 includes receiving a request to provide a decryption cryptographic service type. In some examples, the request is received by a cryptographic hardware component (e.g., the cryptographic hardware component 200 shown in FIG. 2 and described above). In some examples, the request is received from any entity (e.g., hardware, software, firmware, or any combination thereof) seeking to perform decryption of data for any purpose. As an example, a software image (or any other type of data) may have been encrypted by a remote computing device (e.g., a server) prior to be stored on a storage device of a local computing device (e.g., a mobile computing device). In such a scenario, the encryption may be performed pursuant to any of the AES type encryption algorithms (e.g., CBC, GCM, etc.), which encrypt data, at least in part, using a cryptographic key and an IV. Accordingly, decrypting the data, at least in part, uses the same key and IV used during the encryption process.

At block 804, the process 800 includes initiating, in response to the request, an encryption algorithm. In some examples, the encryption algorithm is executed using an algorithm execution device (e.g., the algorithm execution device 204 shown in FIG. 2) of a cryptographic hardware component (e.g., the cryptographic hardware component 200 shown in FIG. 2). In some examples, initiating the execution of an encryption algorithm includes configuring hardware (e.g., circuitry), software, or a combination thereof of the algorithm execution device to execute the encryption algorithm specified in the request received in block 802.

At block 806 the process 800 includes obtaining the encrypted data on which the encryption algorithm will execute (e.g., a software image encrypted by a remote computing device). As an example, the encrypted data may be received at a data receiver (e.g., data receiver 202 shown in FIG. 2) of a cryptographic hardware component (e.g., the cryptographic hardware component 200 shown in FIG. 2), and from there provided to an algorithm execution device (e.g., algorithm execution device 204 shown in FIG. 2). The data may be obtained from any storage device (e.g., the UFS device 104 shown in FIG. 1, the additional storage device 110 shown in FIG. 1, etc.). In some examples, the data on which the encryption algorithm will operate is a portion of the data for which decryption is requested. As such, the data may be received in a series of discrete units (e.g., blocks, segments, etc.), and each such discrete unit of data may be used as input to the decryption algorithm separately to decrypt the encrypted data as a whole.

At block 808, the process 800 includes obtaining the cryptographic key and IV used to encrypt the data. The key and IV may be obtained using any appropriate technique. As an example, the key may be obtained using any suitable key derivation and/or exchange procedure between the remote device where the data was encrypted, and the local device having the cryptographic hardware component (e.g., the cryptographic hardware component 200 shown in FIG. 2) and storing the encrypted data. As another example, the IV may be transmitted from the remote device to the local device where the encrypted data is stored.

At block 810, the process 800 includes storing the key and the IV obtained in block 808 in one or more storage devices of the cryptographic hardware component (e.g., the cryptographic hardware component 200 shown in FIG. 2). In some examples, the IV is stored by the cryptographic hardware component instead of, for example, a sequence number that would otherwise be used to derive an IV, thereby offloading the derivation of the IV from compute resources of the local computing device.

At block 812, the process 800 includes executing the encryption algorithm used to encrypt the data at a remote device to obtain decrypted data (e.g., a cryptographic result). As an example, the cryptographic hardware component 200 shown in FIG. 2 may execute the encryption algorithm using the encrypted data, and the key and IV stored by the cryptographic hardware component in block 810.

At block 814, the process 800 includes storing the decrypted data obtained in block 812 in one or more memory devices of the local computing device having the cryptographic hardware component (e.g., the cryptographic hardware component 200 shown in FIG. 2), which may be referred to as performing at least a portion of a cryptographic action. In some examples, the decryption may be considered inline decryption. As such the decryption may, for example, be performed sequentially on discrete portions of the encrypted data as it is transferred from a storage device to the one or more memory devices.

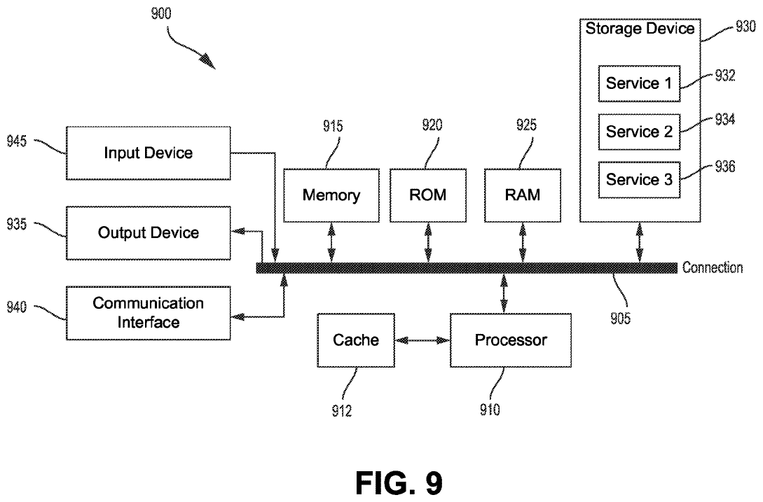

In some examples, the processes 300, 400, 500, 600, 700, 800, or any other process described herein may be performed by a computing device or apparatus, and/or one or more components therein. As an example, the processes may be performed wholly or in part by the cryptographic hardware component 106 of computing device 100 shown in FIG. 1. As another example, the processes 300, 400, 500, 600, 700, and 800 may be performed wholly or in part by the cryptographic hardware component 200 shown in FIG. 2. As another example, the processes may be performed wholly or in part by the computing system 900 shown in FIG. 9, which, though not illustrated in FIG. 9, may include at least one cryptographic hardware component.

The computing device can include any suitable device, such as a vehicle or a computing device of a vehicle (e.g., a driver monitoring system (DMS) of a vehicle), a mobile device (e.g., a mobile phone), a desktop computing device, a tablet computing device, a wearable device (e.g., a VR headset, an AR headset, AR glasses, a network-connected watch or smartwatch, or other wearable device), a server computer, a robotic device, a television, and/or any other computing device with the resource capabilities to perform the processes described herein, including the processes 300, 400, 500, 600 and/or other process described herein. In some cases, the computing device or apparatus may include various components, such as one or more input devices, one or more output devices, one or more processors, one or more microprocessors, one or more microcomputers, one or more cameras, one or more sensors, one or more cryptographic hardware components, and/or other component(s) that are configured to carry out the operations of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented, at least in part, using computer software, firmware, or any combination thereof, to perform the various operations described herein.

The processes 300 shown in FIG. 3, 400 shown in FIG. 4, 500 shown in FIG. 5, 600 shown in FIG. 6, 700 shown in FIG. 7, and 800 shown in FIG. 8 are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes 300, 400, 500, 600, 700, 800, and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 9 is a diagram illustrating an example of a system for implementing certain aspects of the present technology. In particular, FIG. 9 illustrates an example of computing system 900, which can be for example any computing device making up internal computing system, a remote computing system, a camera, or any component thereof in which the components of the system are in communication with each other using connection 905. Connection 905 can be a physical connection using a bus, or a direct connection into processor 910, such as in a chipset architecture. Connection 905 can also be a virtual connection, networked connection, or logical connection.

In some examples, computing system 900 is a distributed system in which the functions described in this disclosure can be distributed within a datacenter, multiple data centers, a peer network, etc. In some examples, one or more of the described system components represents many such components each performing some or all of the function for which the component is described. In some examples, the components can be physical or virtual devices.

Example system 900 includes at least one processing unit (CPU or processor) 910 and connection 905 that couples various system components including system memory 915, such as read-only memory (ROM) 920 and random access memory (RAM) 925 to processor 910. Computing system 900 can include a cache 912 of high-speed memory connected directly with, in close proximity to, or integrated as part of processor 910.

Processor 910 can include any general purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms. In some instances, multimodal systems can enable a user to provide multiple types of input/output to communicate with computing system 900. Computing system 900 can include communications interface 940, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash storage, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 930 can include software services, servers, services, etc., that when the code that defines such software is executed by the processor 910, it causes the system to perform a function. In some examples, a hardware service that performs a particular function can include the software component stored in a computer-readable medium in connection with the necessary hardware components, such as processor 910, connection 905, output device 935, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some examples the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the examples and examples provided herein. However, it will be understood by one of ordinary skill in the art that the examples may be practiced without these specific details. For clarity of explanation, in some instances the present technology may be presented as including individual functional blocks including functional blocks comprising devices, device components, operations, steps, or routines in a method embodied in software, hardware, or combinations of hardware and software. Additional components may be used other than those shown in the figures and/or described herein. For example, circuits, systems, networks, processes, and other components may be shown as components in block diagram form in order not to obscure the examples in unnecessary detail. In other instances, well-known circuits, processes, algorithms, structures, and techniques may be shown without unnecessary detail in order to avoid obscuring the examples.

Individual examples may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional operations not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples thereof, but those skilled in the art will recognize that the application is not limited thereto. Thus, while illustrative examples of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, examples described herein can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate examples, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm operations described in connection with the examples disclosed herein may be implemented as electronic hardware, computer software, firmware, or combinations thereof. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1: A method of offloading cryptographic services, the method comprising: receiving a request to provide a cryptographic service type; initiating a cryptographic algorithm in a cryptographic hardware component, wherein the cryptographic algorithm is associated with the cryptographic service type; applying a cryptographic operation to data to obtain a cryptographic result, wherein the cryptographic operation is associated with the cryptographic algorithm; and storing at least a portion of the cryptographic result in a hardware register of the cryptographic hardware component, wherein the cryptographic result is configured for use for performing a cryptographic action.

Aspect 2: The method of aspect 1, wherein the cryptographic service type comprises an integrity service, the cryptographic algorithm is a hashing algorithm, and the cryptographic result comprises a digest corresponding to the data.

Aspect 3: The method of any one of aspects 1 or 2, further comprising performing the cryptographic action using the cryptographic result.

Aspect 4: The method of any one of aspects 1 to 3, wherein performing the cryptographic action comprises: obtaining the cryptographic result from the hardware register of the cryptographic hardware component; and performing a comparison between the cryptographic result and an expected cryptographic result to determine whether the cryptographic result and the expected cryptographic result match

Aspect 5: The method of aspect 4, further comprising: determining a match between the cryptographic result and the expected cryptographic result; and determining, based on the match between the cryptographic result and the expected cryptographic result, at least a partial integrity check pass for the data

Aspect 6: The method of aspect 4, further comprising: determining that the cryptographic result and the expected cryptographic result do not match; and determining, based on the cryptographic result and the expected cryptographic result not matching, an integrity check failure for the data.

Aspect 7: The method of any one of aspects 6, further comprising: updating an error register of the cryptographic hardware component with an indication of the integrity check failure.

Aspect 8: The method of any one of aspects 1 to 7, wherein the cryptographic operation is performed during a secure boot process, and wherein the data is at least a portion of an operating system image file.

Aspect 9: The method of any one of aspects 1 to 8, wherein the cryptographic operation is performed during a data block integrity check, and wherein the data is at least a portion of a read-only file system.

Aspect 10: The method of aspect 1, wherein the cryptographic service type comprises an authenticated encryption service, wherein the cryptographic algorithm is an authenticated encryption algorithm, and applying the cryptographic operation to obtain the cryptographic result comprises generating a message authentication code (MAC).

Aspect 11: The method of any one of aspects 1 or 10, wherein applying the cryptographic operation to the data to obtain the cryptographic result further comprises encrypting the data using the authenticated encryption algorithm to obtain encrypted data.

Aspect 12: The method of any one of aspects 1 and 10 to 11, further comprising performing the cryptographic action using the cryptographic result, wherein performing the cryptographic action comprises: obtaining the MAC from the hardware register of the cryptographic hardware component; and storing the MAC in persistent memory.

Aspect 13: The method of any one of aspects 1 and 10 to 12, wherein the encrypted data comprises encrypted system state information obtained from memory, and the method further comprises: storing the encrypted data on a non-volatile storage device.

Aspect 14: The method of any one of aspects 1 or 10, wherein the data is encrypted system state information obtained from a non-volatile storage device, and wherein performing the cryptographic action comprises: obtaining the MAC from the hardware register of the cryptographic hardware component; and performing a comparison between the MAC and an expected MAC to determine whether the MAC and the expected MAC match.

Aspect 15: The method of any one of aspects 1 and 14, further comprising: determining that the MAC and the expected MAC match; determining, based on the MAC and the expected MAC matching, an authentication check pass for the data; and decrypting, based on the authentication check pass, the data using the cryptographic algorithm.

Aspect 16: The method of any one of aspects 1 and 14, further comprising: determining that the MAC and the expected MAC do not match; determining, based on the MAC and the expected MAC not matching, an authentication check failure for the data; and updating, based on the authentication check failure, an error register of the cryptographic hardware component with an indication of the authentication check failure.

Aspect 17: An apparatus for offloading cryptographic services, comprising: a memory; a processor; and a cryptographic hardware component coupled to the memory and the processor, and configured to: receive a request to provide a cryptographic service type; initiate a cryptographic algorithm in the cryptographic hardware component, wherein the cryptographic algorithm is associated with the cryptographic service type; apply a cryptographic operation to data to obtain a cryptographic result, wherein the cryptographic operation is associated with the cryptographic algorithm; and store at least a portion of the cryptographic result in a hardware register of the cryptographic hardware component, wherein the cryptographic result is configured for use for performing a cryptographic action.

Aspect 18: The apparatus of aspect 17, wherein the cryptographic service type comprises an integrity service, the cryptographic algorithm is a hashing algorithm, and the cryptographic result comprises a digest corresponding to the data, and wherein the cryptographic hardware component is further configured to perform the cryptographic action using the cryptographic result, wherein, to perform the cryptographic action the cryptographic hardware component is further configured to: obtain the cryptographic result from the hardware register of the cryptographic hardware component; and perform a comparison between the cryptographic result and an expected cryptographic result to determine whether the cryptographic result and the expected cryptographic result match

Aspect 19: The apparatus of any one of aspects 17 or 18, wherein the cryptographic hardware component is further configured to: determine a match between the cryptographic result and the expected cryptographic result; and determine, based on the match between the cryptographic result and the expected cryptographic result, at least a partial integrity check pass for the data.

Aspect 20: The apparatus of any one of aspects 17 or 18, wherein the cryptographic hardware component is further configured to: determine that the cryptographic result and the expected cryptographic result do not match; determine, based on the cryptographic result and the expected cryptographic result not matching, an integrity check failure for the data; and update an error register of the cryptographic hardware component with an indication of the integrity check failure.

Aspect 21: The apparatus of any one of aspects 17 to 20, wherein the cryptographic operation is performed during a secure boot process, and wherein the data is at least a portion of an operating system image file.

Aspect 22: The apparatus of any one of aspects 17 to 20, wherein the cryptographic operation is performed during a data block integrity check, and wherein the data is at least a portion of a read-only file system.

Aspect 23: The apparatus of any one or aspects 17 to 20, wherein the cryptographic service type comprises an authenticated encryption service, wherein the cryptographic algorithm is an authenticated encryption algorithm, and applying the cryptographic operation to obtain the cryptographic result comprises generating a message authentication code (MAC).

Aspect 24: The apparatus of any one of aspects 17 or 23, wherein applying the cryptographic operation to the data to obtain the cryptographic result further comprises encrypting the data using the authenticated encryption algorithm to obtain encrypted data, and wherein the cryptographic hardware component is further configured to perform the cryptographic action using the cryptographic result.

Aspect 25: The apparatus of any one of aspects 17 and 23 or 24, wherein, to perform the cryptographic action, the cryptographic hardware component is further configured to: obtain the MAC from the hardware register of the cryptographic hardware component; and store the MAC in persistent memory.

Aspect 26: The apparatus any one of aspects 17 or 23 to 25, wherein the encrypted data comprises encrypted system state information obtained from memory, and the cryptographic hardware component is further configured to: store the encrypted data on a non-volatile storage device.

Aspect 27: The apparatus of any one of aspects 17 or 23, wherein the data is encrypted system state information obtained from a non-volatile storage device, and wherein, to perform the cryptographic action, the cryptographic hardware component is further configured to: obtain the MAC from the hardware register of the cryptographic hardware component; and perform a comparison between the MAC and an expected MAC to determine whether the MAC and the expected MAC match.

Aspect 28: The apparatus of any one of aspects 17 or 27, wherein the cryptographic hardware component is further configured to: determine that the MAC and the expected MAC match; determine, based on the MAC and the expected MAC matching, an authentication check pass for the data; and decrypt, based on the authentication check pass, the data using the cryptographic algorithm.

Aspect 29: The apparatus of any one of aspects 17 or 27, wherein the cryptographic hardware component is further configured to: determine that the MAC and the expected MAC do not match; determine, based on the MAC and the expected MAC not matching, an authentication check failure for the data; and update, based on the authentication check failure, an error register of the cryptographic hardware component with an indication of the authentication check failure.

Aspect 30: A non-transitory computer-readable medium having stored thereon instructions that, when executed by one or more processors, cause the one or more processors to perform operations according to any of Aspects 1 to 29.

Aspect 31: An apparatus for offloading cryptographic services including one or more means for performing operations according to any of Aspects 1 to 29.

Aspect 32: A method of offloading cryptographic services, the method comprising: receiving, at a local computing device, a request to provide a cryptographic service type comprising a decryption of encrypted data, wherein the encrypted data is encrypted by a remote computing device using plaintext data, a cryptographic key, and an initialization vector (IV); initiating, in response to receiving the request, an encryption algorithm in a cryptographic hardware component of the local computing device; obtaining, by the local computing device, the cryptographic key and the IV; storing the IV in a hardware storage device of the cryptographic hardware component; obtaining the encrypted data from a storage device of the local computing device; executing the encryption algorithm using the encrypted data, the cryptographic key, and the IV to obtain decrypted data; and storing the decrypted data in a memory device of the local computing device.

Aspect 33: An apparatus for offloading cryptographic services, comprising: at least one memory; and at least one processor coupled to the at least one memory and configured to: receive a request to provide a cryptographic service type comprising a decryption of encrypted data, wherein the encrypted data is encrypted by a remote computing device using plaintext data, a cryptographic key, and an initialization vector (IV); initiate, in response to receiving the request, an encryption algorithm in a cryptographic hardware component of the apparatus; obtain the cryptographic key and the IV; store the IV in a hardware storage device of the cryptographic hardware component; obtain the encrypted data from a storage device of the apparatus; execute the encryption algorithm using the encrypted data, the cryptographic key, and the IV to obtain decrypted data; and store the decrypted data in a memory device of the apparatus.

Aspect 34: A non-transitory computer-readable medium of a local computing device having stored thereon instructions that, when executed by one or more processors, cause the one or more processors to: receive a request to provide a cryptographic service type comprising a decryption of encrypted data, wherein the encrypted data is encrypted by a remote computing device using plaintext data, a cryptographic key, and an initialization vector (IV); initiate, in response to receiving the request, an encryption algorithm in a cryptographic hardware component of the local computing device; obtain the cryptographic key and the IV; store the IV in a hardware storage device of the cryptographic hardware component; obtain the encrypted data from a storage device of the local computing device; execute the encryption algorithm using the encrypted data, the cryptographic key, and the IV to obtain decrypted data; and store the decrypted data in a memory device of the local computing device.

Aspect 35: An apparatus for offloading cryptographic services including: means for receiving a request to provide a cryptographic service type comprising a decryption of encrypted data, wherein the encrypted data is encrypted by a remote computing device using plaintext data, a cryptographic key, and an initialization vector (IV); means for initiating, in response to receiving the request, an encryption algorithm in a cryptographic hardware component of the apparatus; means for obtaining the cryptographic key and the IV; means for storing the IV in a hardware storage device of the cryptographic hardware component; means for obtaining the encrypted data from a storage device of the apparatus; means for executing the encryption algorithm using the encrypted data, the cryptographic key, and the IV to obtain decrypted data; and means for storing the decrypted data in a memory device of the apparatus.

What is claimed is:

1. A method of offloading cryptographic services, the method comprising:
receiving a request to provide a cryptographic service type;
initiating a cryptographic algorithm in a cryptographic hardware component, wherein the cryptographic algorithm is associated with the cryptographic service type;
applying a cryptographic operation to data to obtain a cryptographic result, wherein the cryptographic operation is associated with the cryptographic algorithm; and
storing at least a portion of the cryptographic result in a hardware register of the cryptographic hardware component, wherein the cryptographic result is configured for use for performing a cryptographic action.

2. The method of claim 1, wherein the cryptographic service type comprises an integrity service, the cryptographic algorithm is a hashing algorithm, and the cryptographic result comprises a digest corresponding to the data.

3. The method of claim 1, further comprising performing the cryptographic action using the cryptographic result.

4. The method of claim 3, wherein performing the cryptographic action comprises:
obtaining the cryptographic result from the hardware register of the cryptographic hardware component; and
performing a comparison between the cryptographic result and an expected cryptographic result to determine whether the cryptographic result and the expected cryptographic result match.

5. The method of claim 4, further comprising:
determining a match between the cryptographic result and the expected cryptographic result; and
determining, based on the match between the cryptographic result and the expected cryptographic result, at least a partial integrity check pass for the data.

6. The method of claim 4, further comprising:
determining that the cryptographic result and the expected cryptographic result do not match; and
determining, based on the cryptographic result and the expected cryptographic result not matching, an integrity check failure for the data.

7. The method of claim 6, further comprising:
updating an error register of the cryptographic hardware component with an indication of the integrity check failure.

8. The method of claim 1, wherein the cryptographic operation is performed during a secure boot process, and wherein the data is at least a portion of an operating system image file.

9. The method of claim 1, wherein the cryptographic operation is performed during a data block integrity check, and wherein the data is at least a portion of a read-only file system.

10. The method of claim 1, wherein the cryptographic service type comprises an authenticated encryption service, wherein the cryptographic algorithm is an authenticated encryption algorithm, and applying the cryptographic operation to obtain the cryptographic result comprises generating a message authentication code (MAC).

11. The method of claim 10, wherein applying the cryptographic operation to the data to obtain the cryptographic result further comprises encrypting the data using the authenticated encryption algorithm to obtain encrypted data.

12. The method of claim 11, further comprising performing the cryptographic action using the cryptographic result, wherein performing the cryptographic action comprises:
obtaining the MAC from the hardware register of the cryptographic hardware component; and
storing the MAC in persistent memory.

13. The method of claim 12, wherein the encrypted data comprises encrypted system state information obtained from memory, and the method further comprises:
storing the encrypted data on a non-volatile storage device.

14. The method of claim 10, wherein the data is encrypted system state information obtained from a non-volatile storage device, and wherein performing the cryptographic action comprises:
obtaining the MAC from the hardware register of the cryptographic hardware component; and
performing a comparison between the MAC and an expected MAC to determine whether the MAC and the expected MAC match.

15. The method of claim 14, further comprising:
determining that the MAC and the expected MAC match;
determining, based on the MAC and the expected MAC matching, an authentication check pass for the data; and
decrypting, based on the authentication check pass, the data using the cryptographic algorithm.

16. The method of claim 14, further comprising:
determining that the MAC and the expected MAC do not match;
determining, based on the MAC and the expected MAC not matching, an authentication check failure for the data; and
updating, based on the authentication check failure, an error register of the cryptographic hardware component with an indication of the authentication check failure.

17. An apparatus for offloading cryptographic services, comprising:
at least one memory;
at least one processor; and
a cryptographic hardware component coupled to the at least one memory and the at least one processor, and configured to:
receive a request to provide a cryptographic service type;
initiate a cryptographic algorithm in the cryptographic hardware component, wherein the cryptographic algorithm is associated with the cryptographic service type;
apply a cryptographic operation to data to obtain a cryptographic result, wherein the cryptographic operation is associated with the cryptographic algorithm; and
store at least a portion of the cryptographic result in a hardware register of the cryptographic hardware component, wherein the cryptographic result is configured for use for performing a cryptographic action.

18. The apparatus of claim 17, wherein the cryptographic service type comprises an integrity service, the cryptographic algorithm is a hashing algorithm, and the cryptographic result comprises a digest corresponding to the data, and wherein the cryptographic hardware component is further configured to perform the cryptographic action using the cryptographic result, wherein, to perform the cryptographic action, the cryptographic hardware component is further configured to:
obtain the cryptographic result from the hardware register of the cryptographic hardware component; and
perform a comparison between the cryptographic result and an expected cryptographic result to determine whether the cryptographic result and the expected cryptographic result match.

19. The apparatus of claim 18, wherein the cryptographic hardware component is further configured to:
determine a match between the cryptographic result and the expected cryptographic result; and
determine, based on the match between the cryptographic result and the expected cryptographic result, at least a partial integrity check pass for the data.

20. The apparatus of claim 18, wherein the cryptographic hardware component is further configured to:
determine that the cryptographic result and the expected cryptographic result do not match;
determine, based on the cryptographic result and the expected cryptographic result not matching, an integrity check failure for the data; and
update an error register of the cryptographic hardware component with an indication of the integrity check failure.

21. The apparatus of claim 17, wherein the cryptographic hardware component is configured to perform the cryptographic operation during a secure boot process, and wherein the data is at least a portion of an operating system image file.

22. The apparatus of claim 17, wherein the cryptographic hardware component is configured to perform the cryptographic operation during a data block integrity check, and wherein the data is at least a portion of a read-only file system.

23. The apparatus of claim 17, wherein the cryptographic service type comprises an authenticated encryption service, wherein the cryptographic algorithm is an authenticated encryption algorithm, and wherein, to apply the cryptographic operation to obtain the cryptographic result, the cryptographic hardware component is configured to generate a message authentication code (MAC).

24. The apparatus of claim 23, wherein, to apply the cryptographic operation to the data to obtain the cryptographic result, the cryptographic hardware component is configured to encrypt the data using the authenticated encryption algorithm to obtain encrypted data, and wherein the cryptographic hardware component is further configured to perform the cryptographic action using the cryptographic result.

25. The apparatus of claim 24, wherein, to perform the cryptographic action, the cryptographic hardware component is further configured to:
obtain the MAC from the hardware register of the cryptographic hardware component; and
store the MAC in persistent memory.

26. The apparatus of claim 25, wherein the encrypted data comprises encrypted system state information obtained from memory, and the cryptographic hardware component is further configured to:
store the encrypted data on a non-volatile storage device.

27. The apparatus of claim 23, wherein the data is encrypted system state information obtained from a non-volatile storage device, and wherein, to perform the cryptographic action, the cryptographic hardware component is further configured to:
obtain the MAC from the hardware register of the cryptographic hardware component; and
perform a comparison between the MAC and an expected MAC to determine whether the MAC and the expected MAC match.

28. The apparatus of claim 27, wherein the cryptographic hardware component is further configured to:
determine that the MAC and the expected MAC match;
determine, based on the MAC and the expected MAC matching, an authentication check pass for the data; and
decrypt, based on the authentication check pass, the data using the cryptographic algorithm.

29. The apparatus of claim 27, wherein the cryptographic hardware component is further configured to:
determine that the MAC and the expected MAC do not match;
determine, based on the MAC and the expected MAC not matching, an authentication check failure for the data; and
update, based on the authentication check failure, an error register of the cryptographic hardware component with an indication of the authentication check failure.

30. A method of offloading cryptographic services, the method comprising:
receiving, at a local computing device, a request to provide a cryptographic service type comprising a decryption of encrypted data, wherein the encrypted data is encrypted by a remote computing device using plaintext data, a cryptographic key, and an initialization vector (IV);
initiating, in response to receiving the request, an encryption algorithm in a cryptographic hardware component of the local computing device;
obtaining, by the local computing device, the cryptographic key and the IV;
storing the IV in a hardware storage device of the cryptographic hardware component;
obtaining the encrypted data from a storage device of the local computing device;
executing the encryption algorithm using the encrypted data, the cryptographic key, and the IV to obtain decrypted data; and
storing the decrypted data in a memory device of the local computing device.
